(19) United States
(12) Patent Application Publication
(10) Pub. No.: US 2018/0059969 A1
(43) Pub. Date: Mar. 1, 2018

(54) STORAGE SYSTEM INCLUDING A CONNECTION UNIT AND A PLURALITY OF NETWORKED STORAGE NODES

(71) Applicant: Toshiba Memory Corporation, Tokyo (JP)

(72) Inventors: Kazuhiro FUKUTOMI, Yokohama Kanagawa (JP); Takahiro KURITA, Sagamihara Kanagawa (JP); Kazunari SUMIYOSHI, Yokohama Kanagawa (JP); Kazunari KAWAMURA, Akishima Tokyo (JP)

(21) Appl. No.: 15/442,148

(22) Filed: Feb. 24, 2017

(30) Foreign Application Priority Data
Aug. 29, 2016 (JP) 2016-166904

(51) Int. Cl. G06F 3/06

(52) U.S. Cl. CPC G06F 3/0619; G06F 3/065; G06F 3/0679; G06F 3/0659; G06F 3/067

(57) ABSTRACT

A storage system includes a plurality of nodes, each of the nodes including a nonvolatile storage device, and a connection unit directly connected to at least one of the nodes and having a processor. The processor is configured to store each of input or output (I/O) commands in a queue, issue each of the data I/O commands stored in the queue to one of the nodes to be accessed in accordance with the data I/O command, determine a busy node based on a status received therefrom, and selectively generate I/O commands for storage in the queue so that I/O commands targeting non-busy nodes are generated and I/O commands targeting busy nodes are not generated.

### CROSS-REFERENCE TO RELATED APPLICATION

This application is based upon and claims the benefit of priority from Japanese Patent Application No. 2016-166904, filed Aug. 29, 2016, the entire contents of which are incorporated herein by reference.

### FIELD

Embodiments described herein relate generally to a technology for controlling a storage system including a nonvolatile memory.

### BACKGROUND

Recently, in accordance with dramatic increase in amount of data handled by companies, a distributed storage system that includes a plurality of storage devices and processes a large amount of data and various kinds of data in a high-speed and efficient manner has been developed.

Furthermore, storage devices that store data in a nonvolatile memory has been used more widely. As these storage devices, a solid state drive (SSD) and an embedded multi-media card (eMMC®) are known. Because of low power consumption and high-speed performance, these storage devices are widely used as the main storage for various computing devices.

However, in the distributed storage system, delay of one storage device may lead to delay of the entire distributed storage system.

### DESCRIPTION OF THE DRAWINGS

FIG. 1 is a block diagram of a storage system according to an embodiment.

FIG. 2 is a block diagram of an example of the storage system according to the embodiment.

FIG. 3 is a block diagram of a connection unit (CU) included in the storage system according to the embodiment.

FIG. 4 is a block diagram of a node module (NM) included in the storage system according to the embodiment.

FIG. 5 illustrates a relationship among an application software program, a queue, and a plurality of storages in the storage system according to the embodiment.

FIG. 6 illustrates an ideal concurrency level and an actual concurrency level in the storage system according to the embodiment.

FIG. 7 describes a factor of causing a low concurrency level.

FIGS. 8-10 illustrate a result of analysis of the low concurrency level.

FIG. 11 describes a case where the application software program waits for completion of execution of all commands.

FIG. 12 describes a basic concept of I/O management (Part 1) that is performed by the storage system according to the embodiment.

FIG. 13 illustrates an example of a status acquisition operation that is applied to the storage system according to the embodiment.

FIG. 14 describes an outline of an operation that is performed by the storage system according to the embodiment in response to detection of a slow storage.

FIG. 15 is a flowchart illustrating a procedure for processing that is performed by the storage system according to the embodiment in response to the detection of the slow storage.

FIG. 16 is a flowchart illustrating a procedure for data I/O request control processing that is performed in accordance with execution of the application software program.

FIG. 17 describes an outline of an operation that is performed by the storage system according to the embodiment based on prediction of the storage that is likely to become slow.

FIG. 18 is a flowchart illustrating a procedure for processing that is performed by the storage system according to the embodiment based on the prediction of the storage that is likely to become slow.

FIG. 19 is a flowchart illustrating another procedure for the data I/O request control processing that is performed in accordance with execution of the application software program.

FIG. 20 is a flowchart illustrating a procedure for processing performed by the storage system according to the embodiment based on both of specification of the storage that is likely to become slow and the detection of the slow storage.

FIG. 21 describes measures that are taken by a connection unit (CU) driver or the node module (NM) of the storage system according to the embodiment.

FIG. 22 illustrates a configuration in which a queue is prepared for every processor core.

FIG. 23 illustrates a configuration in which the queue is prepared for every normal module (NM).

FIG. 24 illustrates a configuration in which a large-sized queue is prepared in a higher layer.

FIG. 25 is a flowchart illustrating a procedure for processing for selecting each of the data I/O requests that are able to be sent, from the data I/O requests that are entered into the queue of the higher layer.

FIG. 26 describes an outline of an operation of controlling a request to the node module (NM).

FIG. 27 is a flowchart illustrating a procedure for controlling the request to the node module (NM).

FIG. 28 describes an outline of an operation of starting a background operation of the storage that becomes in an idle state.

FIG. 29 is a flowchart illustrating a procedure for starting the background operation of the storage that becomes in the idle state.

FIG. 30 describes a concept of the second I/O management (Part 2) that is performed by the storage system according to the embodiment.

FIG. 31 describes an outline of an operation of writing data that are to be written to the slow storage to a reserved save area.

FIG. 32 describes an outline of an operation of regarding the command that exceeds a fixed time after being entered into the queue as having a timeout error.

FIG. 33 is a flowchart illustrating a procedure for regarding the command that exceeds a fixed time after being entered into the queue as having the timeout error.

FIG. 34 describes a basic concept that is employed by the connection unit (CU) driver and the node module (NM).

FIG. 35 is a flowchart illustrating a procedure for writing subsequent data that are to be written to the slow storage to the reserved save area.

FIG. 36 describes an outline of an operation of toggling a writing-target storage between two storages.

FIG. 37 is a timing chart illustrating the operation of toggling the writing-target storage between the two addresses.

FIG. 38 is a flowchart illustrating a procedure for toggling the writing-target storage between the two storages.

FIG. 39 describes an outline of an operation of writing the data that are to be written to the slow storage to a storage dedicated to save.

FIG. 40 is a timing chart illustrating an operation in which the data that are to be written to the slow storage are temporarily written to the storage dedicated to save and later that data are returned to an original storage.

FIG. 41 is a flowchart illustrating a procedure for temporarily writing the data which are to be written to the slow storage to the storage dedicated to save, and later returns that data to the original storage.

FIG. 42 describes an outline of an operation of writing the data that are to be written to the slow storage to a RAM within the node module (NM).

FIG. 43 is a flowchart illustrating a procedure for temporarily writing the data which are to be written to the slow storage to the RAM within the node module (NM) and later returns that data to the original storage.

FIG. 44 describes an outline of an operation of writing the data that are to be written to the slow storage to a reserved save area within any other storage.

FIG. 45 is a timing chart illustrating an operation in which the data that are to be written to the slow storage are temporarily written to a reserved save area within any other storage, and later that data are returned to the original storage.

FIG. 46 is a flowchart illustrating a procedure for temporarily writing the data that are to be written to the slow storage to the reserved save area within any other storage, and later returns that data to the original storage.

### DETAILED DESCRIPTION

An embodiment provides a storage system that can maintain a preferable performance level during operation thereof.

According to an embodiment, a storage system includes a plurality of nodes, each of the nodes including a nonvolatile storage device, and a connection unit directly connected to at least one of the nodes and having a processor. The processor is configured to store each of input or output (I/O) commands in a queue, issue each of the data I/O commands stored in the queue to one of the nodes to be accessed in accordance with the data I/O command, determine a busy node based on a status received therefrom, and selectively generate I/O commands for storage in the queue so that I/O commands targeting non-busy nodes are generated and I/O commands targeting busy nodes are not generated.

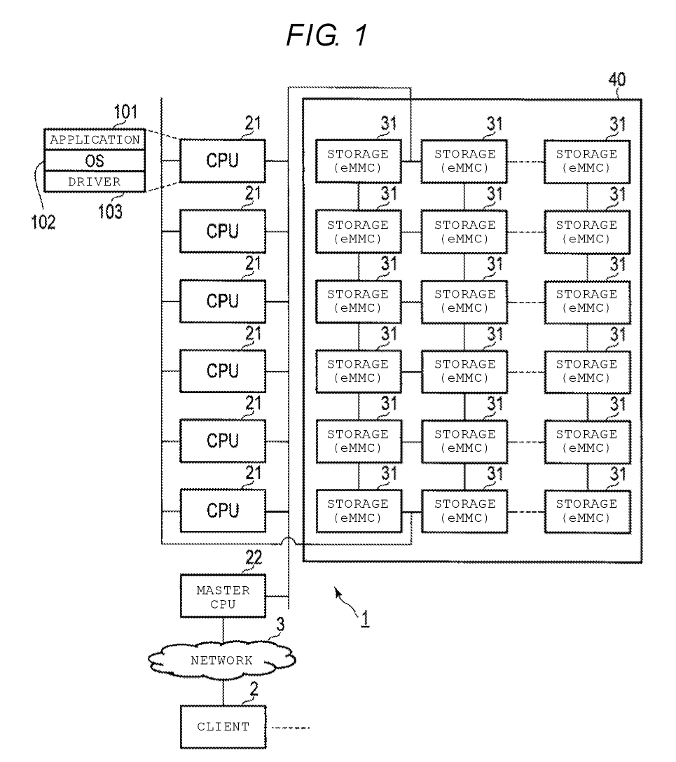

Embodiments will be described below with reference to the drawings. First, a configuration of a storage system according to an embodiment is described with reference to FIG. 1.

A storage system 1 is configured in such a manner that processing including various data operations (data writing, data reading, and the like) is performed according to a request from each of a plurality of clients 2. The storage system 1 can store all pieces of data in a nonvolatile memory such as a NAND flash memory.

The storage system 1 can include a plurality of CPUs (a plurality of processors) 21, a master CPU (a master processor) 22, and a plurality of storages 31.

Each of the plurality of storages 31 includes a nonvolatile memory such as a NAND flash memory. Each storage 31 functions as a semiconductor storage device that is configured to write data to a nonvolatile memory thereof and to read data from the nonvolatile memory.

For example, each storage 31 is implemented by an embedded multi-media card (eMMC®), a solid state drive (SSD), or another type of semiconductor storage that includes a nonvolatile memory. Here it is assumed that each storage 31 is an eMMC.

Each storage 31 has a plurality of input and output ports. The plurality of storages 31 is connected to one another through their respective input and output ports. The storages 31 that are connected to one another logically serve as a high-volume data storing area (a storage array) 40.

The storages 31 are shared by the plurality of CPUs (the plurality of processors) 21. That is, in the storage system 1, any CPU 21 can access each of the storages 31 within the data storing area 40, and shared data within the data storing area 40 can be processed in parallel by the plurality of CPUs (the plurality of processors) 21. Therefore, the storage system 1 can function as a distributed data processing system that is capable of performing parallel processing of the shared data within the data storing area 40 using the plurality of CPUs 21.

The master CPU 22 receives a request from the client 2 through a network 3, and allocates processing (which is also referred to as a job) in accordance with the request to one or more CPUs 21. Each CPU 21 to which the processing is allocated performs various data operations that are associated with this job. For example, each CPU 21 accesses (performs the data writing to or performs the data reading into) several of the storages 31 in parallel, performs certain data processing on the read data if need arises, and then returns a response (a writing completion response or a reading completion response) or a result of the processing of the data to the master CPU 22. The master CPU 22 receives the response and the result of the processing of the data from each of the CUPs 21 to which the processing was allocated, integrates the responses or the results of the processing of the data, and transmits the integrated responses or the integrated results of the processing of the data to the client 2 through the network 3.

In the above, the example of the system configuration of the system, in which a dedicated processor is used as the master CPU 22, is described above, but at least one of the plurality of CPUs 21 may serve as the master CPU 22. In this case, there is no need to provide the dedicated master CPU 22.

Each of the plurality of CPUs 21 performs an application software program 101, an operating system (OS) 102, and a driver software program 103.

The application software program 101 is executed to perform the processing that is allocated by the master CPU (the master processor) 22. The application software program 101 can be executed to access data in the data storing area (the storage array) 40 through the operating system 102 and the driver software program 103. In more detail, the application software program 101 is executed to issue a data input and output (I/O) request that is destined for all or several of the storages (eMMC) 31. The data I/O requests are requests for data access, such as a writing command for writing data and a reading command for reading data.

When viewed from the client 2, the application software program 101 in each CPU 21 functions as a server application to perform various services according to a request from the client 2.

The driver software program 103 is a software program that is configured in such a manner that each storage 31 is accessed. The driver software program 103 may be so-called firmware. Each CPU 21 executes the driver software program 103. According to each of the data I/O request that, with the execution of the driver software program 103, is issued from the application software program 101, each CPU 21 accesses all or several of the storages (eMMC) 31.

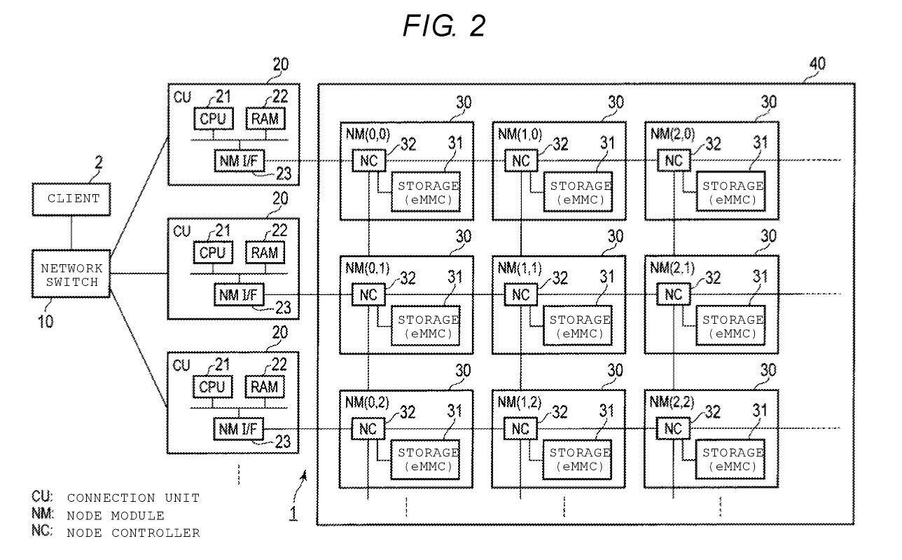

FIG. 2 illustrates an example of the storage system 1.

In FIG. 2, the storage system 1 includes a network switch 10, a plurality of connection units (CUs) 20, and a plurality of node modules (NMs) 30.

Each node module (NM) 30 functions as one storage node. Each node module (NM) 30 includes one storage 31 described above and a node controller (NC) 32. The node controller (NC) 32 executes access control of the storage 31 within the node module (NM) 30 and transfer control of the data I/O request and data.

The node controller (NC) 32 has a plurality of input and output ports (for example, four input and output ports). The plurality of node modules (NM) 30 is connected, for example, in a matrix configuration, by connecting their respective input and output ports to one another. The connection is not limited to the matrix configuration.

The plurality of connection units (CUs) 20 is connected to the client 2 through the network switch 10. Each connection unit (CU) 20 includes one CPU 21, a RAM (for example, a DRAM) 22, and a node module interface (NM I/F) 23. Any one of the plurality of connection units (CUs) 20 may function as the master CPU 22 described above.

The plurality of connection units (CUs) 20 is connected directly to different one of the node modules (NMs) 30, respectively. In each connection unit (CU) 20, the node module interface (NM I/F) 23 is connected to the node controller (NC) 32 within the corresponding node module (NM) 30. More precisely, each connection unit (CU) 20 is connected directly to corresponding one of the node modules (NM) 30 through the node module interface (NM I/F) 23, and is connected indirectly to all of the other node modules (NM) 30 through the corresponding node module (NM) 30.

Whenever the data I/O request (the command) is sent to a destination that is one of the node modules (NM) 30, each connection unit (CU) 20 first sends the data I/O request (that command) to the node module (NM) 30 that is directly connected to the connection unit (CU) 20. Thereafter, the data I/O request (the command) is automatically transferred to the target node module (NM) 30 through one or more node modules (NMs) 30, the target node module is not the directly-connected node module.

For example, if the plurality of node modules (NMs) 30 is connected to one another in the matrix configuration that is defined by a plurality of rows and a plurality of columns, coordinates (M, N) indicating a position within the matrix configuration at which those node modules (NMs) 30 are arranged may be assigned, as an identifier (a node address) thereof, to those node modules (NMs) 30. M indicates a row number and N indicates a column number. For example, an identifier (a node address) of the node module (NM) 30 that is positioned at the upper left corner of the matrix configuration is (0, 0).

In each node module (NM) 30, the node controller (NC) 32 compares an identifier (a destination address) of a destination that is included within the data I/O request, with the identifier (the node address) of the NM 30 itself, and then determines whether or the received data I/O request is a data I/O request that is destined for the NM 30 itself.

If the received data I/O request is not a data I/O request that is destined for the NM 30 itself, the node controller (NC) 32 determines the neighboring node module (NM) 30 to which the received data I/O request is to be transferred, from a relationship in magnitude between the row number and the column number of the identifier of the NM 30 itself and the row number and the column number of an identifier of the destination within the received data I/O request.

Furthermore, as is the case when the data I/O request described above is transferred, with operation of each of the plurality of NCs 31, a result (a command processing completion response, read data, or the like) of the access is also transferred from the accessed node module (NM) 30 to the connection unit (CU) 20 that issues the data I/O request. Furthermore, although not illustrated, the connection unit (CU) 20 may have a plurality of node module interfaces (NM I/Fs) 23. The node module interfaces (NM I/Fs) 23 may be connected to different node controllers (NC) 32, respectively. Accordingly, access performance in the normal time can be improved, and also when the node module interface (NM I/F) 23, the node controller (NC) 32, or the like malfunctions, failure resistance can be increased.

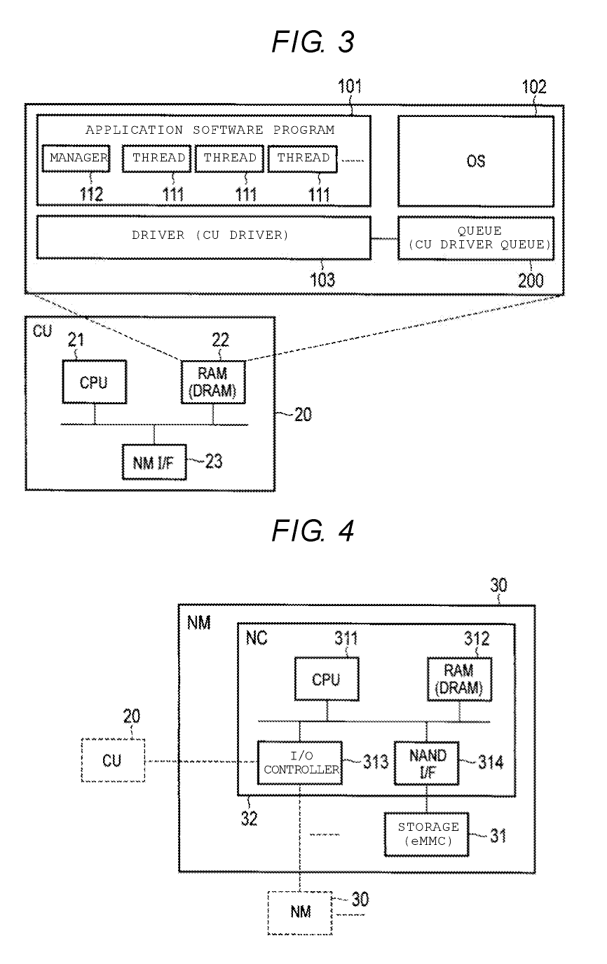

FIG. 3 illustrates a configuration of each connection unit (CU) 20.

In each connection unit (CU) 20, the CPU 21 executes the application software program 101, the operating system 102, and the driver software program (a CU driver) 103 in the RAM (for example, the DRAM) 32. A plurality of threads 111 runs on the application software program 101. The threads 111 may issue the data I/O request that is destined for different storages (eMMCs) 31. Furthermore, the application software program 101 includes a manager 112. The manager 112 is executed to control each thread 111. For example, the manager 112 may be executed to cause a specific thread 111 to be in a sleep state if needed, and additionally, may be executed to wake up the specific thread 111 in the sleep state if needed. Additionally, the manager 112 can acquire a status of a target storages (eMMC) 31 by communicating with the driver software program (the CU driver) 103 if needed.

Additionally, a queue 200 is prepared in the RAM 32. The queue 200 is a queue (a CU driver queue) that is managed by the driver software program (CU driver) 103. Each of the data I/O requests that are issued by the application software program 101 is input into the queue 200. The CPU 21 sends each of the data I/O requests within the queue 200 to the corresponding storage (eMMC) 31 under the control of the driver software program (the CU driver) 103. The storage (eMMC) 31 determines that a data size (for example, 8 sectors, 4 KiB, or the like) suitable for the access is present in addition to a minimum data size (for example, 1 sector, 512 byte, or the like) that is allowed for a command for the reading or the writing. Accumulation of the data I/O requests in such a manner that a reading and writing size suitable for the access is ensured is pointed out as one of the purposes of preparing the queue.

FIG. 4 illustrates a configuration of each node module (NM) 30.

As described above, the NM 30 includes the node controller (NC) 32 and the storage (eMMC) 31. The node controller (NC) 32 includes a CPU 311, a RAM (for example, the DRAM) 312, an I/O controller 313, and a NAND interface 314. Each function of the node controller (NC) 32 is implemented by executing a software program that is stored in the RAM 312. The I/O controller 313 includes one I/O port for the connection unit (CU) 20 and four I/O ports for the node module (NM) 30. Alternatively, one portion or all portions of the node controller (NC) 32 may be built into field-programmable gate array (FPGA). Furthermore, one node controller (NC) 32 may be built into one FPGA, and additionally, a plurality of node controllers (NCs) 32 may be integrally built into one FPGA.

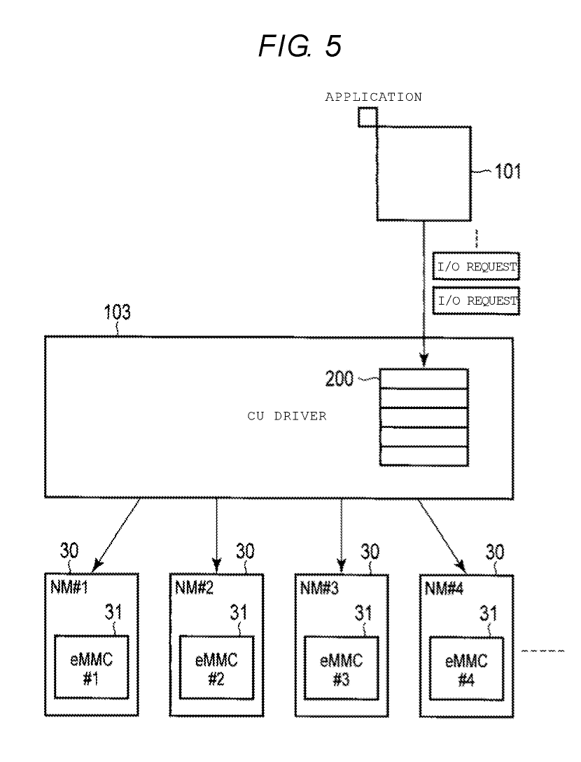

FIG. 5 illustrates a relationship among the application software program 101, the queue 103, and the plurality of storages (eMMCs) 31.

For the data writing, the data reading, or the like, the application software program 101 is executed to issue the data I/O request (for example, the writing command, the reading command, or the like) that is destined for several of the storages 31. Each storage (eMMC) 31 may have a logical block address range (LBA range (LBA 0 to LBA n)) that corresponds to a capacity thereof.

Each of the data I/O requests may include a destination address (a destination identifier) that designates one storage (eMMC) 31. If the data I/O request is a data writing request (the writing command), the data I/O request may further include a starting LBA, a data transfer length, and data to be written. The starting LBA indicates the first logical block address for writing the data. If the data I/O request is the data reading request (the reading command), the data I/O request may include the starting LBA and the data transfer length. The starting LBA indicates the first logical block address from which the data are to be read.

Each of the data I/O requests that are issued by the application software program 101 is input into the queue 200 of the CU driver software program 103. The CU driver software program 103 sends each of the data I/O requests within the queue 200, which are able to be sent, toward each of the storages (eMMCs) 31 that correspond to the data I/O requests which are able to be sent. Each piece of the data I/O requests that are not able to be sent remains within the queue 200 without being sent from the queue 200.

Examples of the data I/O request that is not able to be sent include a data I/O request that is destined for the slow storage (the slow eMMC) 31 of which access speed becomes low because of background operations that include garbage collection.

In a storage that includes a nonvolatile memory, such as a NAND flash memory, in some cases, the time (which is referred to as latency or a response time) taken between receiving the data I/O request (the command) and completing execution of the command is not always constant and the latency becomes occasionally extremely high. Usually, the storage (eMMC) 31 can be data-accessed at high speed (low latency). However, the storage (eMMC) 31 occasionally performs the background operations that include the garbage collection. The latency becomes extremely high while performing the background operation (the garbage collection). More precisely, the storage (eMMC) 31 that causes the background operation to be in progress is the slow storage (the slow eMMC) 31. The latency that is extremely high is referred to as “giant latency”.

Usually, when free space in a nonvolatile memory (a NAND flash memory) within a certain storage (eMMC) 31 falls below a threshold, the storage (the eMMC) 31 automatically starts the background operation (the garbage collection) in order to increase the free space. Because the background operation (the garbage collection) increases the number of free blocks within the NAND flash memory, only valid data are collected in another block (a free block) using several blocks in which valid data and invalid data are both present in a mixed manner. In a garbage collection operation, the valid data are read from several blocks in which the valid data and the invalid data are both present, and the read valid data are copied to a certain block (a free block). As a result of the copying, the valid data are collected in several specific blocks (free blocks). Each block in which only the invalid data remains by the valid data being copied to the free block is able to be reused as a free block after the invalid data are erased.

The sending of each of the writing commands to the storage (eMMC) 31 causes the garbage collection operation in the storage (eMMC) 31, and as a result, the latency in the storage (eMMC) 31 become occasionally extremely long (or high) (the giant latency).

Usually, the latency of the writing command is 200 microseconds or less. On the other hand, the giant latency, for example, is approximately 20 to 30 milliseconds.

The ease with which the giant latency occurs differs depending on an access pattern. Generally, the following is known.
The giant latency easily occurs at the time of small-sized data random writing (for example, 4 KiB random writing).
The giant latency easily occurs at the time of random writing in a wide range (for example, random writing in a 100% range). More precisely, the higher a ratio (a percentage) of the range of the random writing to a capacity of the storage, the more the giant latency is likely to occur.
The giant latency occurs with difficulty at the time of sequential writing.

If a certain storage (eMMC) 31 becomes a slow eMMC by performing the background operations that include the garbage collection, more precisely, if the giant latency occurs in a certain storage (a certain eMMC) 31, in some cases, the driver software program (the CU driver) 103 cannot efficiently send the data I/O request (the command). The reason for this is as follows.

The command that is destined for the slow eMMC remains within the queue 200 without being sent from the queue 200. Therefore, if the driver software program (the CU driver) 103 is configured to pick up a command that is destined for any other eMMC among arbitrary entries within the queue 200, it is likely that the queue 200 will soon become extremely full of commands that are destined for the slow eMMC. If the queue 200 is full of the commands that are destined for the slow eMMC, a new command that is destined for any other storage (a different eMMC) 31 cannot be entered into the queue 200. Therefore, in a certain storage (a certain eMMC) 31, in some cases, while the giant latency occurs, efficiency of the access to any other eMMCs 31 as well as to the eMMC 31 in which the giant latency occurs decreases.

As a result, a concurrency level of the access would be compromised and performance of the storage system 1 decreases.

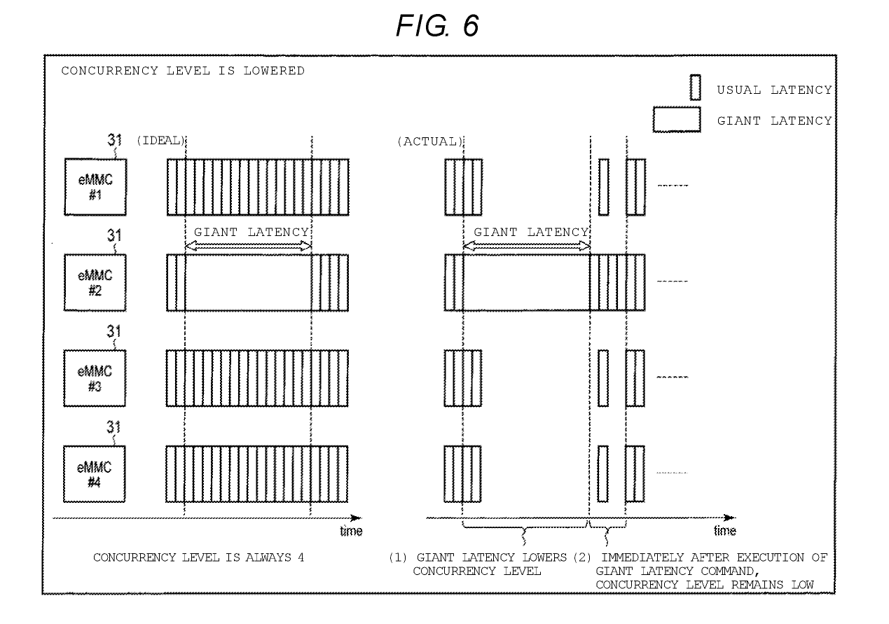

FIG. 6 illustrates a relationship between an ideal concurrency level and an actual concurrency level in the storage system.

In FIG. 6, a case where four eMMC (eMMC #1, eMMC #2, eMMC #3, and eMMC #4) are accessed in parallel is assumed. In FIG. 6, a rectangle with narrow width indicates the usual latency, and a rectangle with broad width indicates the giant latency.

Even though the giant latency occurs in eMMC #2, as illustrated in the left portion of FIG. 6, ideally, the concurrency level is always the highest concurrency level (4 in this example).

However, actually, as illustrated in the right portion of FIG. 6, in some cases, while the giant latency occurs in eMMC #2, commands that are destined for eMMC #1, eMMC #3, and eMMC #4 in which the giant latency does not occur cannot be efficiently sent. For this reason, the giant latency degrades the concurrency level.

The ending of the background operation (the garbage collection) soon ends the execution of the command that is accompanied by the extremely-high latency (a giant latency command). However, just after the execution of the giant latency command is ended, the concurrency level is also maintained in a low state as is. The low concurrency level is a factor in causing decrease in the performance of the storage system 1.

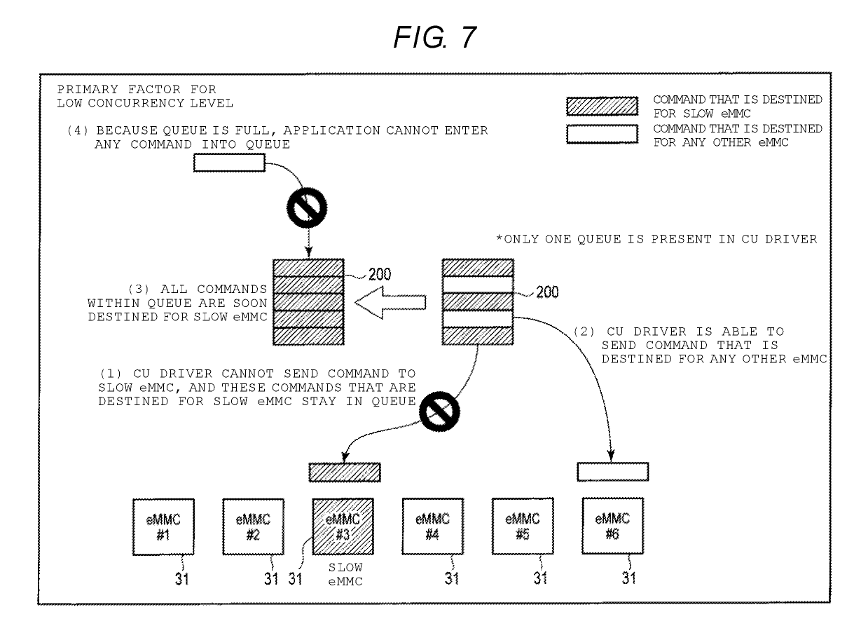

FIG. 7 illustrates a factor of causing the low concurrency level.

(1) The driver software program (the CU driver) 103 cannot send the command that is destined for the slow eMMC, and the commands that are destined for the slow eMMC stay in the queue 200.

(2) The driver software program (the CU driver) 103 is able to send the command that is destined for any other eMMC.

(3) All the commands within the queue 200 become soon ones that are destined for the slow eMMC.

(4) Because the queue 200 is full, the application software program 101 cannot enter any command into the queue 200.

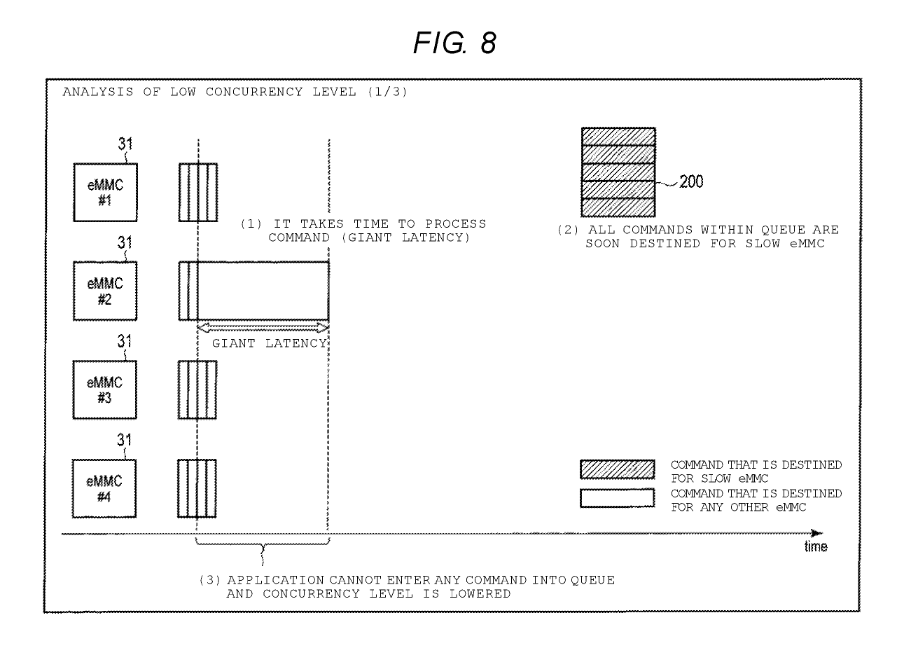

Analysis of the low concurrency level will be described in detail below with reference to FIGS. 8 to 10.

(1) As illustrated in FIG. 8, for example, when eMMC #2 starts the background operation, it takes a long time to process the command in eMMC #2 (giant latency).

(2) All the commands within the queue 200 are ones that are destined for the slow eMMC (slow eMMC #2).

(3) The application software program 101 cannot enter any command into the queue 200, and thus the concurrency level falls.

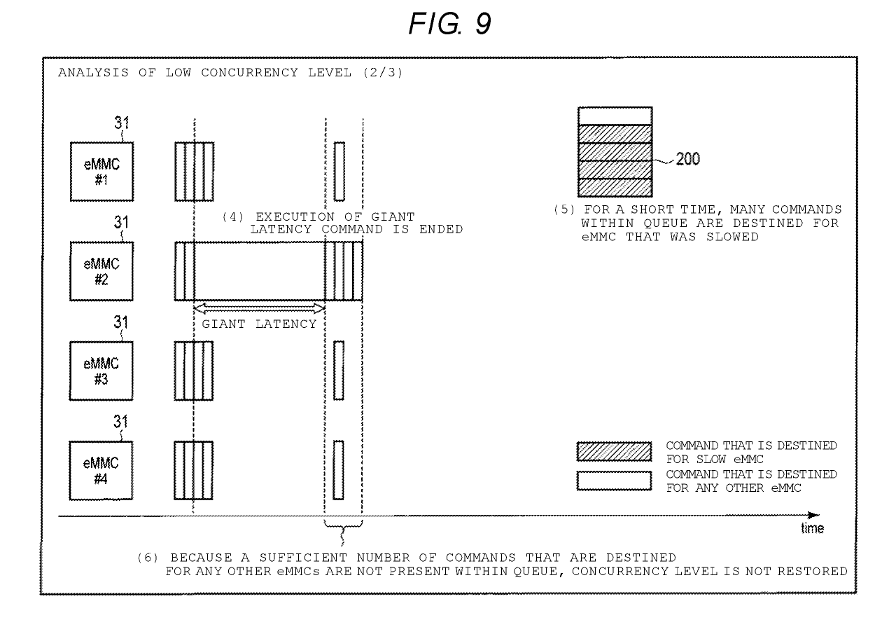

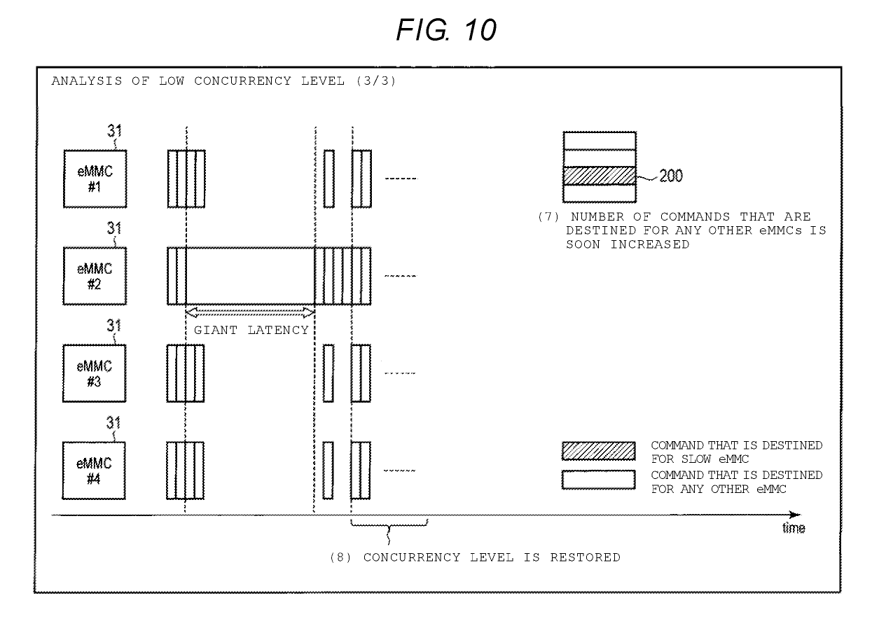

(4) As illustrated in FIG. 9, completion of the background operation in eMMC #2 soon ends the execution of the giant latency command. Accordingly, the latency of eMMC #2 is restored to latency during normal use (normal latency).

(5) However, for a short while, many commands within the queue 200 are ones that are destined for the eMMC (eMMC #2) that was slowed.

(6) A sufficient number of commands that are destined for other eMMCs (eMMC #1, eMMC #3, and eMMC #4) are not present within the queue 200, the concurrency level is not restored.

(7) As illustrated in FIG. 10, the number of commands that are destined for other eMMCs (eMMC #1, eMMC #3, and eMMC #4) increases in the queue 200.

(8) Consequently, the concurrency level is restored.

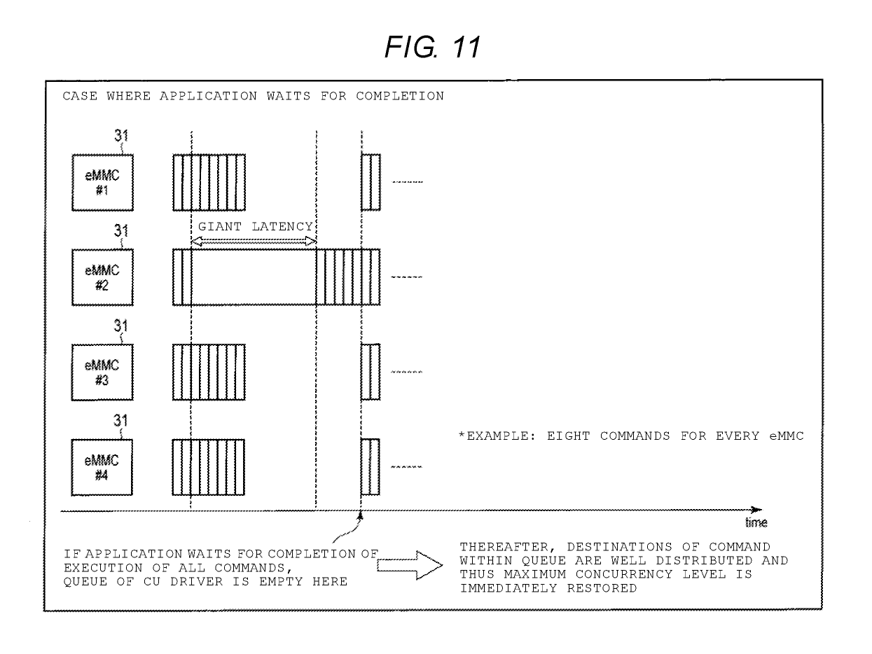

FIG. 11 illustrates a case where the application software program 101 waits for the completion of the execution of all the commands.

If the application software program 101 waits for the completion of the execution of all the command, the application software program 101 does not proceed to the next processing until the execution of all the commands is completed. In this case, the decrease in the performance by the giant latency will not become apparent.

FIG. 11 illustrates a case where the application software program 101 waits the completion of the execution of eight commands for every eMMC.

If the application software program 101 waits for the completion of the execution of all the commands, the queue 200 is empty until the execution of all the commands (the eight commands here) that are destined for the eMMC (eMMC #2) which is slowed are completed. Thereafter, destinations of the commands within the queue 200 are well distributed, and thus the highest concurrency level is immediately restored.

From the analysis described above, the following are understood.

The driver software program (the CU driver) 103 has only one queue 200. For this reason, if it takes a long time for a certain eMMC to execute the command, the queue 200 is full of the commands that are destined for the slow eMMC, and cannot receive the command that is destined for any other eMMC. As a result, the concurrency level falls. Just after ending the execution of the giant latency command, many commands within the queue 200 are commands that are destined for the eMMC that was slow. Any other eMMC cannot receive a sufficient number of commands, and thus the concurrency level is maintained in a low state.

In the case where the application software program 101 waits for the completion of the execution of all the commands, the decrease in the performance by the giant latency will not become apparent.

Therefore, in the case where the application software program 101 waits for the completion of the execution of all the commands, even though measures are taken to avoid the falling of the concurrency level during a period of the giant latency, effects is unlikely to be achieved, but in other cases, measures are required to avoid the falling of the concurrency level.

The measures are broadly categorized into the following two parts.

Part 1: Method of Efficiently Using the Queue

1-1: Cooperation with the application software program.

1-2: Cope in the CU driver or the NM.

Part 2: Method of Achieving Performance Improvement by Causing the Writing Command to Overlay the Giant Latency

2-1: Cooperation with the application software program.

2-2: Cope in the CU driver or the NM.

First, Part 1: Method of Efficiently Using the Queue is described.

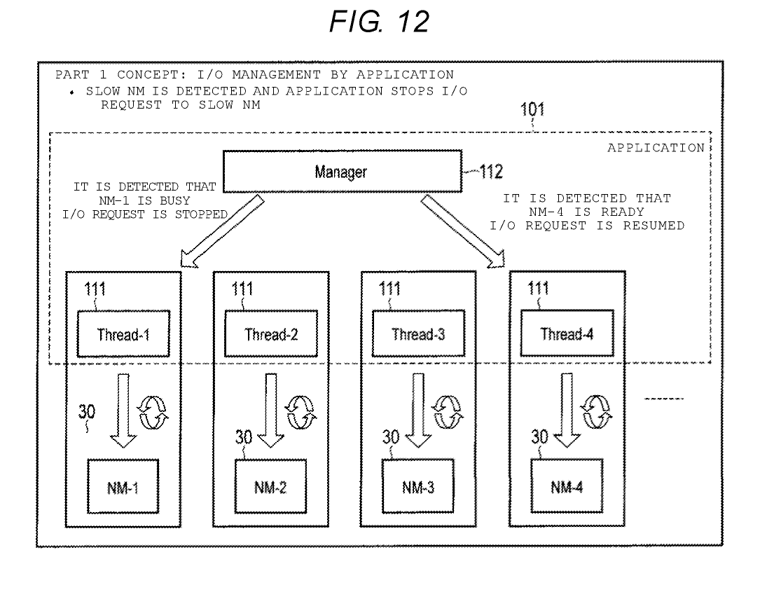

FIG. 12 illustrates the basic concept of I/O management that is performed by the storage system 1.

The application software program 101 detects a slow node module (slow NM), more precisely, a node module that includes the slow eMMC, and stops the issuing of the data I/O request to the slow NM. In this case, the application software program 101 may monitor a status of each NM (more precisely, a status of each eMMC) with polling, and thus may detect the slow NM. Alternatively, the driver software program (the CU driver) 103 may detect the slow NM by monitoring the status of each NM (more precisely, the status of each eMMC), and may notify the application software program 101 of the slow NM.

Alternatively, based on the status that is notified by each NM, the application software program 101 or the driver software program (the CU driver) 103 may detect the slow NM.

In FIG. 12, a case where with the polling, or the notification by the driver software program (the CU driver) 103 or by each NM, the manager 112 of the application software program 101 detects the status (BUSY or IDLE) of each NM is assumed.

BUSY indicates that an access speed of the eMMC within a certain NM becomes low. IDLE indicates that the eMMC within a certain NM is able to operate with usual latency.

Four threads (Thread-1, Thread-2, Thread-3, and Thread-4) 111 run on the application software program 101. Thread-1 issues each of the data I/O requests for accessing NM-1. Thread-2 issues each of the data I/O requests for accessing NM-2. Thread-3 issues each of the data I/O requests for accessing NM-3. Thread-4 issues each of the data I/O requests for accessing NM-4. Moreover, the number of threads is not limited to four. Furthermore, the association of the thread and the NM that is an access destination is not limited thereto. It is possible that terms or phases in the following description are suitably replaced.

When the manager 112 detects that NM-1 is BUSY, the manager 112 controls Thread-1, and thus stops the issuing of the data I/O request to Thread-1 (the data I/O request that is destined for NM-1). In this case, the manager 112 may make Thread-1 SLEEP. The stopping of the issuing of the data I/O request that is destined for NM-1 can ensure an empty area into which a new data I/O request that is destined for any other NM is able to be entered, within queue 200. Because of this, the queue 200 can receive the new data I/O request that is destined for any other NM. Consequently, while the giant latency occurs to NM-1, the data I/O request is able to be efficiently sent to any other NM.

The new data I/O request that is destined for NM-1 that becomes slow cannot be issued. However, even though the new data I/O request that is destined for NM-1 which becomes slow is issued and is entered into the queue 200, the data I/O request cannot be sent to NM-1 until the latency of NM-1 that becomes slow is restored. Therefore, even though the issuing of the new data I/O request that is destined for NM-1 which becomes slow is stopped, this does not cause any bad influence.

Thereafter, when the manager 112 detects that NM-1 is READY, the manager 112 controls Thread-1, and thus resumes the issuing of the data I/O request to Thread-1 (the data I/O request that is destined for NM-1). In this case, the manager 112 may make Thread-1 WAKE UP. Accordingly, the concurrency level is restored to the highest concurrency level.

In the same manner, when the manager 112 detects that NM-4 is BUSY, the manager 112 controls Thread-4, and thus stops the issuing of the data I/O request to Thread-4 (the data I/O request that is destined for NM-4). In this case, the manager 112 may make Thread-4 SLEEP. Thereafter, when the manager 112 detects that NM-4 is READY, the manager 112 controls Thread-4, and thus resumes the issuing of the data I/O request to Thread-4 (the data I/O request that is destined for NM-4). In this case, the manager 112 may make Thread-4 WAKE UP.

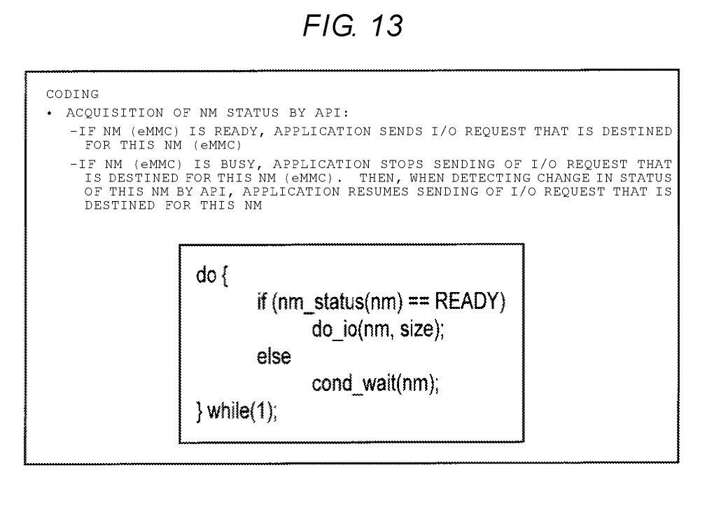

FIG. 13 illustrating an example of a status acquisition operation that is applied to the storage system 1.

The driver software program (the CU driver) 103 has an application software program interface (API) for acquiring an NM status. By using the API, the manager 112 can easily acquire a status of each NM that is a target, from the driver software program (the CU driver) 103.

If the NM (eMMC) is READY, the application software program 101 issues the data I/O request that is destined for the NM (eMMC).

If NM (eMMC) is BUSY, the application software program 101 stops the issuing of the data I/O request that is destined for the NM (eMMC). Then, when a change in the status of the NM (from BUSY to READY) is detected based on the API, the application software program 101 resumes the issuing of the data I/O request that is destined for the NM.

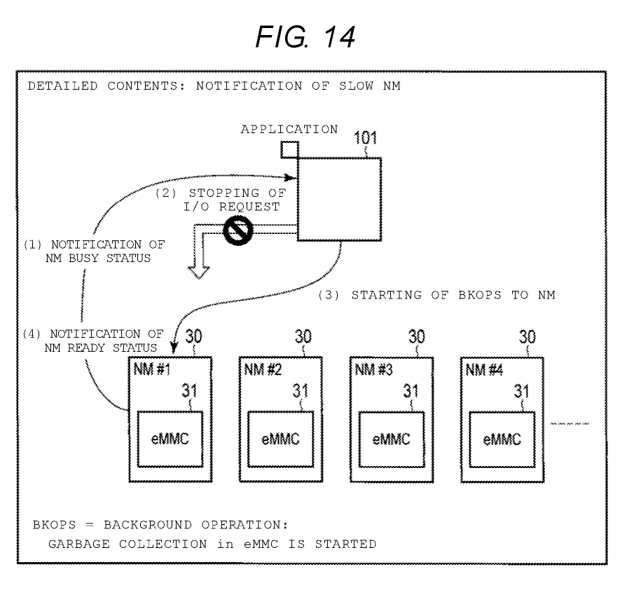

FIG. 14 illustrates an outline of an operation that is performed by the storage system 1 in response to the detection of the slow NM (the slow eMMC).

In FIG. 14, it is assumed that the giant latency occurs in NM #1 (eMMC #1).

(1) When the giant latency occurs in NM #1 (eMMC #1), NM #1 (eMMC #1) is BUSY, NM #1 or the driver software program (the CU driver) 103 may provide a notification to the application software program 101.

(2) The application software program 101 receives a notification that NM #1 (eMMC #1) is BUSY. Then, the application software program 101 stops the issuing of the data I/O request that is destined for slow NM #1 (eMMC #1). The stopping of the issuing of the data I/O request that is destined for slow NM #1 (eMMC #1) can ensure an empty area into which a new data I/O request that is destined for any other NM is able to be entered, within the queue 200. Therefore, the queue 200 can be prevented from being full of the data I/O requests that are destined for slow NM #1 (eMMC #1), and from being unable to receive a data I/O request that is destined for the other NMs.

(3) The application software program 101 may instruct NM #1 (eMMC #1) to start an additional background operation (BKOPS) if needed.

Usually, when it comes to the background operation (the garbage collection (GC)) of which performance is caused by the slow NM to be in progress, in order for the execution of the I/O command to be completed as earlier as possible, the garbage collection operation that creates a minimum amount of necessary free space is carried out. For this reason, when several of the writing commands are sent to the NM after the latency of the slow NM is restored, it is likely that a next GC timing for the NM will come immediately and the NM will start the background operation again. In this case, the NM becomes the slow NM again. Therefore, NM #1 (eMMC #1) is instructed to start the additional background operation (BKOPS) that creates a free space having an amount larger than the minimum amount of necessary free space, and thus it can be expected that the time which is as long as the time it takes for the next GC timing for NM #1 to come is ensured. Moreover, before instructing to start the BKOPS, the application software program 101 may send a trimming command for invalidating unnecessary data to NM #1 (eMMC #1).

(4) When the execution of the giant latency command is ended in NM #1 (eMMC #1), NM #1 (eMMC #1) is READY, NM #1 or the driver software program (the CU driver) 103 may provide a notification to the application software program 101. In response to the notification, the application software program 101 is executed to resume the issuing of the data I/O request that is destined for NM #1 (eMMC #1).

Moreover, while NM #1 (eMMC #1) is BUSY, the application software program 101 may be executed to temporarily write subsequent data, which are to be written to slow NM #1 (eMMC #1), to a reserved save area, and then will return the data from the reserved save area to NM #1 (eMMC #1). In temporarily writing the data to the reserved save area, the application software program 101 is executed to stop the issuing the data writing request (the writing command) that is destined for slow NM #1 (eMMC #1), and instead, issues a different data writing request (a different writing command) for writing the data, which are to be written to eMMC #1, to the reserved save area.

As a result, the application software program 101 does not wait for the ending of the execution of the giant latency command for slow NM #1 (eMMC #1), the subsequent data that are to be written to slow NM #1 (eMMC #1) can be written to the reserved save area. The reserved save area is an arbitrary storage area that is different from slow NM #1 (eMMC #1). For example, the reserved save area may be an eMMC other than slow NM #1 (eMMC #1), may be an eMMC devoted to save, or may be a RAM (a DRAM) within any NM.

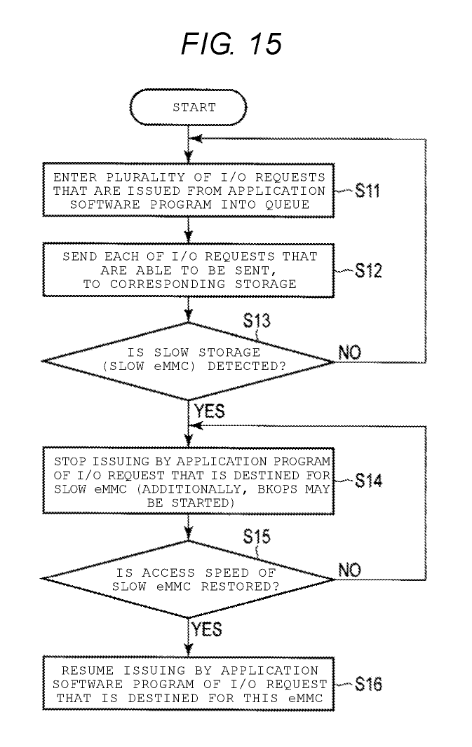

A flowchart in FIG. 15 illustrates a procedure for processing that is performed by the storage system 1 in response to the detection of the slow storage.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S11).

The CPU 21 sends each of the data I/O requests within the queue 200, which are able to be sent, toward each of the storages (eMMCs) 31 that correspond to the data I/O requests which are able to be sent (Step S12).

When the CPU 21 detects the slow storage (the slow eMMC) 31 of which access speed becomes low because of the background operation (YES in Step S13), in a state where the data I/O request that is destined for the slow eMMC 31 stays in the queue 200, the CPU 21 sends a data I/O request that is destined for any other eMMC 31, from the queue 200 to any other eMMC 31. Additionally, the CPU 21 stops the issuing by the application software program 101 of the data I/O request that is destined for the slow eMMC 31 (Step S14). In Step S14, the application software program 101 is executed to stop the issuing of only the data I/O request that is destined for the slow eMMC 31, and continues to issue a data I/O request that is destined for any other eMMC 31. In Step S14, the CPU 21 may instruct the slow eMMC 31 to start the BKOPS.

The stopping by the application software program 101 of the issuing of the data I/O request that is destined for the slow eMMC 31 can ensure an empty area into which a data I/O request that is destined for an eMMC 31 other than the slow eMMC is able to be entered, within the queue 200. As a result, a situation where the queue 200 is full of the data I/O requests that are destined for the slow eMMC 31 and thus cannot receive a command that is destined for any other eMMC can be prevented. Therefore, even though the giant latency occurs in a certain eMMC 31, it can be expected that an ideal state which is illustrated in the left portion of FIG. 6 is achieved. Types of data I/O requests that are targets the issuing of which is to be stopped may be both of the data writing request and the data reading request. Alternatively, only the issuing of the data writing request may be stopped.

Thereafter, the CPU 21 determines whether or not the execution of the giant latency command is ended, more specifically, whether or not an access speed of the slow eMMC 31 is restored to a usual access speed (Step S15). If the access speed of the eMMC 31 is restored (YES in Step S15), the CPU 21 resumes the issuing by the application software program 101 of the data I/O request that is destined for the eMMC 31 (Step S16).

Moreover, as described above, while an access speed of a certain eMMC 31 is low, the application software program 101 may be executed to temporarily write data, which are to be written to the slow eMMC 31, to the reserved save area, and then will return the data from the reserved save area to an original eMMC (the eMMC that was slowed). After the access speed of the slow eMMC 31 is restored to the usual access speed, the data may be returned from the reserved save area to the original eMMC.

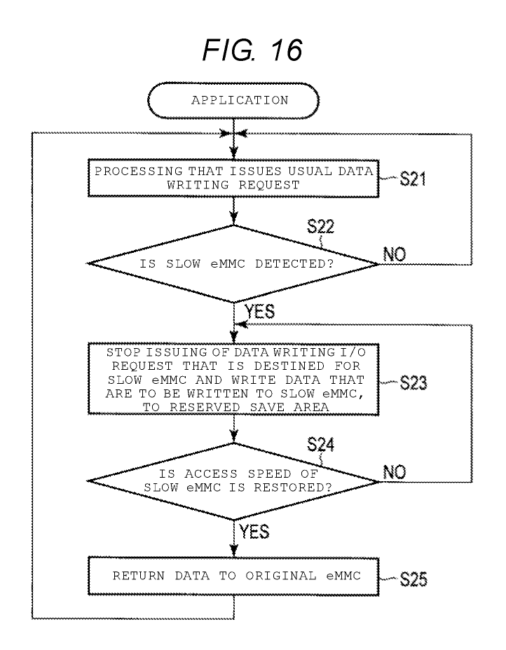

A flowchart in FIG. 16 illustrates a procedure for data I/O request control processing by the application software program 101.

The application software program 101 performs usual data writing request issuing processing that issues each of the data writing requests that are destined for several of the eMMCs which are access targets, until the slow eMMC is detected (Step S21).

If one eMMC among several of the eMMC that are the access targets is detected as the slow eMMC (YES in Step S22), the application software program 101 stops the issuing of the data writing request (the writing command) that is destined for the slow eMMC, and temporarily writes subsequent data, which are to be written to the slow eMMC, to the reserved save area, which is different from the slow eMMC (Step S23). In Step S23, the application software program 101 issues the data writing request (the writing command) that is destined for the reserved save area. The data writing request that is destined for the reserved save area is entered into the queue 200. The data writing request that is destined for the reserved save area is the data I/O request that is able to be sent, and because of this, does not stay for a long time in the queue 200. In Step S23, the application software program 101 additionally stores save information indicating a relationship between an address at which data are to be written and a data save address.

If an access speed of the slow eMMC is restored (YES in Step S24), the application software program 101 is executed to return the data, which are written to the reserved save area, to an original storage position within the eMMC that was slow (Step S25). In Step S25, the application software program 101 additionally deletes the save information that corresponds to the returned data.

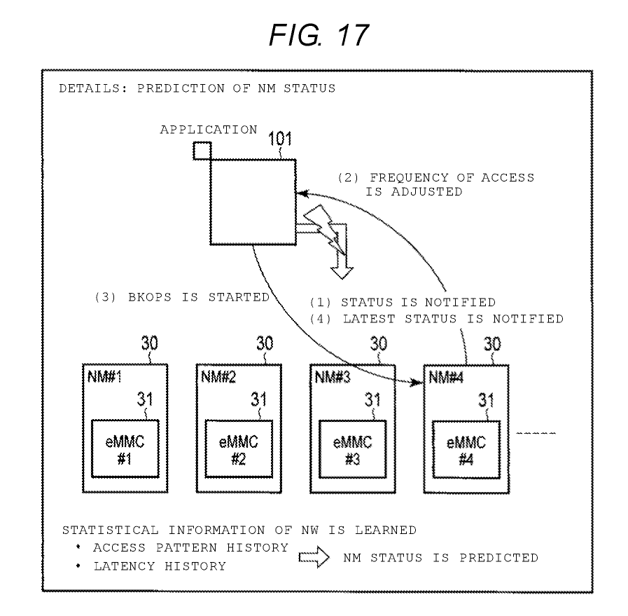

FIG. 17 illustrates an outline of an operation that is performed by the storage system 1 based on a prediction of the storage that is likely to become slow.

The storage system 1 can additionally have a function of predicting an NM (eMMC) that is likely to become slow. The NM (eMMC) that is likely to become slow is a storage of which access speed is expected to become slow from the need to start the background operation (the garbage collection) and may be referred to as a quasi-busy NM (eMMC). The function of predicting the NM (eMMC) that is likely to become slow may be performed by any one of the application software program 101, the driver software program (the CU driver) 103, and each NM (eMMC).

If the application software program 101 performs the prediction function, the application software program 101 predicts an NM (eMMC) that is likely to become slow, and specifies such an NM (eMMC) as a storage that is likely to become slow.

If the driver software program (the CU driver) 103 performs the prediction function, the driver software program (the CU driver) 103 predicts an NM (eMMC) that is likely to become slow, and notifies the application software program 101 of such an NM (eMMC). The application software program 101 can specify the NM (eMMC) as the storage that is likely to become slow.

If each NM (eMMC) performs the prediction function, when each NM (eMMC) itself is predicted to be likely to become slow, each NM (eMMC) may notify the CPUs 21 (for example, the application software programs 101 on all CUs 20) of all CUs 20 that each NM (eMMC) itself is predicted to become slow. Each application software program 101 can specify the NM (eMMC) as the storage that is likely to become slow.

The storage that is likely to become slow is able to be predicted by learning statistical information of each NM. As described above, the ease with which the giant latency occurs differs with the access pattern. Therefore, access pattern history can be used as the statistical information. Alternatively, latency history of each NM may be learned as the statistical information. The prediction function predicts the NM (eMMC) that is likely to become slow, based on the statistical information of each NM (at least one of the access pattern history and the latency history).

In FIG. 17, it is assumed that NM #4 (eMMC #4) is predicted to be an NM (eMMC) that is likely to become slow.

(1) When NM #4 (eMMC #4) is predicted to be an NM (eMMC) that is likely to become slow, NM #4 or the driver software program (the CU driver) 103 may provide a notification indicating that NM #4 (eMMC #4) is the NM (eMMC) that is likely to become slow to the application software program 101.

(2) The application software program 101 receives the notification indicating that NM #4 (eMMC #4) is the NM (eMMC) that is likely to become slow. Then, the application software program 101 is executed to specify NM #4 (eMMC #4) as the storage that is likely to become slow, based on the notification. In this case, the application software program 101 is executed to reduce the number of data I/O requests that are destined for NM #4 (eMMC #4) in such a manner that the frequency with which the access to NM #4 (eMMC #4) occurs is decreased. Accordingly, even though NM #4 (eMMC #4) will become slow actually in the future, the number of commands that are destined for NM #4 (eMMC #4) that stay within the queue 200 can be reduced.

Therefore, even though NM #4 (eMMC #4) will become slow actually in the future, it can be expected that situations where the queue 200 is full of the data I/O requests that are destined for slow NM #4 (eMMC #4) and where the data I/O request that is destined for any other NM cannot be received are prevented beforehand.

Moreover, for a period of time during which the frequency with which the access to NM #4 (eMMC #4) is adjusted, the application software program 101 may be executed to temporarily write subsequent data, which are to be written to NM #4 (eMMC #4), to the reserved save area, and then will return the data from the reserved save area to NM #4 (eMMC #4). After the access speed of the slow eMMC is restored to the usual access speed, the data may be returned from the reserved save area to the original eMMC.

(3) The application software program 101 may instruct NM #4 (eMMC #4) to start an additional background operation (BKOPS) if needed. Usually, the application software program 101 cannot recognize a timing at which the eMMC starts the background operation (the garbage collection). However, according to the present embodiment, the eMMC that is likely to become slow can be predicted and the application software program 101 can be notified that the eMMC is likely to become slow. Therefore, by using this notification, the application software program 101 is able to actively control a timing at which each eMMC starts the GC. Usually, because it takes a long time to perform the BKOPS, while the performance of the BKOPS is in progress, there is a need for the application software program 101 to adjust (decrease) the frequency with which the access occurs.

(4) If a predicted status of NM #4 (eMMC #4) changes, NM #4 or the driver software program (the CU driver) 103 may notify the application software program 101 of the latest status of NM #4 (eMMC #4) as the latest status. For example, the latest status of NM #4 (eMMC #4) may be BUSY. In other words, when NM #4 (eMMC #4) becomes slow actually, the application software program 101 is notified that NM #4 (eMMC #4) is BUSY, as the latest status. In this case, the application software program 101 may be executed to stop the issuing of the data I/O request that is destined for NM #4 (eMMC #4).

If NM #4 (eMMC #4) becomes slow actually, the driver software program (the CU driver) 103 is executed to send data I/O requests that are destined for other eMMCs, from the queue 200 to these other eMMCs, respectively, in a state where the data I/O request that is destined for eMMC #4 stays in the queue 200.

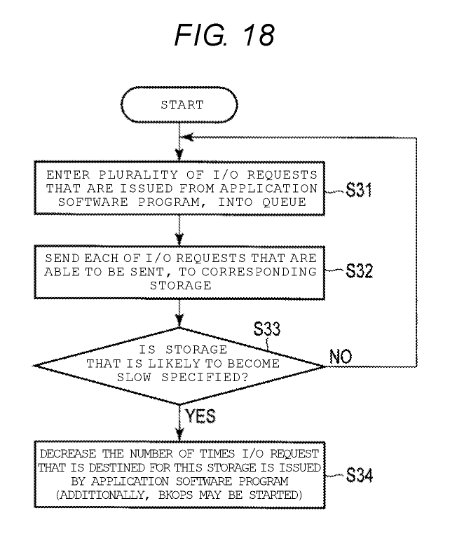

A flowchart in FIG. 18 illustrates a procedure for processing that is performed by the storage system 1 in response to specification of the storage that is likely to become slow.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S31).

The CPU 21 sends each of the data I/O requests within the queue 200, which are able to be sent, toward each of the storages (eMMCs) 31 that correspond to the data I/O requests which are able to be sent (Step S32).

When the storage 31 that is likely to become slow (eMMC that is likely to be slow) is specified (YES in Step S33), the CPU 21 decreases the number of data I/O requests that are destined for the eMMCs 31 that are likely to become slow, which are issued by the application software program 101 (Step S34). In Step S34, the application software program 101 reduces the number of times the data I/O request that is destined for the eMMC 31 which is likely to become slow is issued, and, as usual, continues to issue a data I/O request that is destined for any other eMMC 31. As a result, before the eMMC 31 becomes slow actually, the number of data I/O requests that are destined for the eMMC 31 can be decreased. Therefore, even though the eMMC 31 becomes slow actually, a situation where the queue 200 is full of the data I/O requests that are destined for the slow eMMC 31 and thus a command that is destined for any other eMMC cannot be received can be prevented beforehand. Types of data I/O requests that are targets the number of times of issuing of which is to be decreased may be both of the data writing request and the data reading request. Alternatively, the number of times the data writing request is issued may be decreased.

In Step S34, the CPU 21 may instruct the eMMC 31, which is likely to become slow, to start the BKOPS.

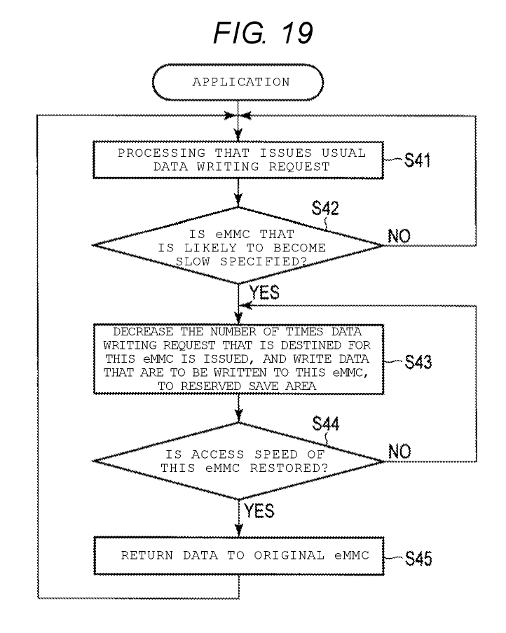

A flowchart in FIG. 19 illustrates a procedure for the data I/O request control processing by the application software program 101.

The application software program 101 performs the usual data writing request issuing processing that issues each of the data writing requests that are destined for several of the eMMCs which are access targets, until the eMMC that is likely to become slow is specified (Step S41).

If one eMMC among several of the eMMC that are the access targets is specified as the eMMC that is likely to become slow (YES in Step S42), the application software program 101 is executed to decrease the number of times that the data writing request (the writing command) that is destined for the eMMC which is likely to become slow is issued, and temporarily writes subsequent data, which are to be written to that eMMC, to the reserved save area, which is different from that eMMC (Step S43). In Step S43, the application software program 101 is executed to issue the data writing request (the writing command) that is destined for the reserved save area. The data writing request that is destined for the reserved save area is entered into the queue 200. The data writing request that is destined for the reserved save area is a data I/O request that is able to be sent, and because of this, does not stay for a long time in the queue 200. In Step S43, the application software program 101 is executed to additionally store the save information indicating the relationship between the address at which data are to be written and the data save address.

After the eMMC that is likely to become slow becomes slow actually, the access speed of the eMMC is sooner or later restored. In this manner, when the access speed of that eMMC is restored (YES in Step S44), the application software program 101 is executed to return the data, which are written to the reserved save area, to the original storage position within that eMMC (Step S45). In Step S45, the application software program 101 additionally deletes the save information that corresponds to the returned data.

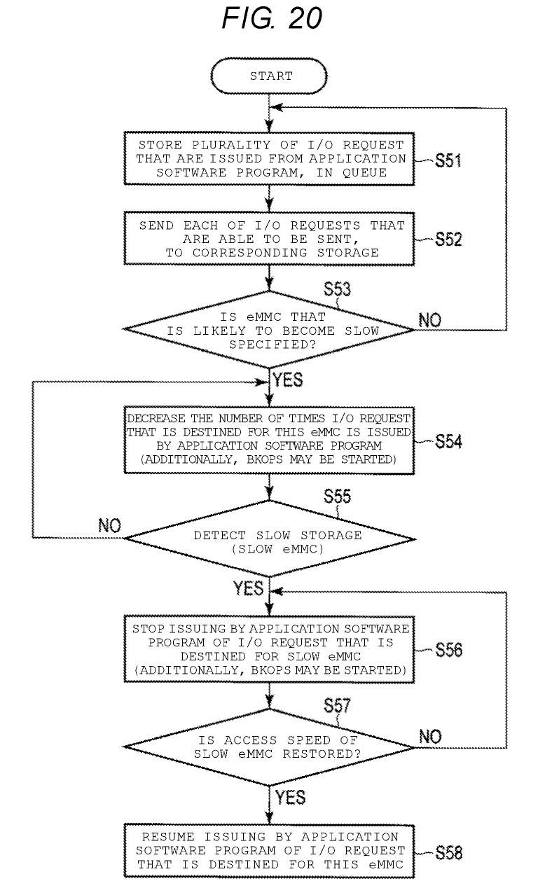

A flowchart in FIG. 20 illustrates a procedure for processing that is performed by the storage system 1 based on both of the specification of the storage that is likely to become slow and the detection of the slow storage.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S51).

The CPU 21 sends each of the data I/O requests within the queue 200, which are able to be sent, toward each of the storages (eMMCs) 31 that correspond to the data I/O requests which are able to be sent (Step S52).

When the storage 31 that is likely to become slow (eMMC that is likely to be slow) is specified (YES in Step S53), the CPU 21 decreases the number of data I/O requests that are destined for the eMMCs 31 that are likely to become slow, which are issued by the application software program 101 (Step S54). In Step S54, the application software program 101 is executed to reduce the number of times the data I/O request that is destined for the eMMC 31 which is likely to become slow is issued, and, as usual, continues to issue a data I/O request that is destined for any other eMMC 31. In Step S54, the CPU 21 may instruct the eMMC 31, which is likely to become slow, to start the BKOPS.

When the CPU 21 detects that the eMMC 31 that is likely to become slow becomes slow actually (YES in Step S55), the CPU 21 sends a data I/O request that is destined for any other eMMC 31 from the queue 200 to the different eMMC 31, in a state where the data I/O request that is destined for the slow eMMC 31 stays in the queue 200. Additionally, the CPU 21 stops the issuing by the application software program 101 of the data I/O request that is destined for the slow eMMC 31 (Step S56). In Step S56, the application software program 101 stops the issuing of the data I/O request that is destined for the slow eMMC 31, and continues to issue a data I/O request that is destined for any other eMMC 31. In Step S56, the CPU 21 may instruct the slow eMMC 31 to start the BKOPS.

Thereafter, the CPU 21 determines whether or not the execution of the giant latency command is ended, more specifically, whether or not the access speed of the slow eMMC 31 is restored to the usual access speed (Step S57). If the access speed of the eMMC 31 is restored (YES in Step S57), the CPU 21 resumes the issuing by the application software program 101 of the data I/O request that is destined for the eMMC 31 (Step S58).

Moreover, in each of Steps S54 and S56, the application software program 101 may be executed to temporarily write subsequent data, which are to be written to the eMMC that is likely to become slow (or the slow eMMC), to the reserved save area.

Then, in Step S58, the application software program 101 is executed to read the data that are written to the reserved area (saved data) from the reserved save area, and then write the saved data to an original eMMC of which access speed is restored.

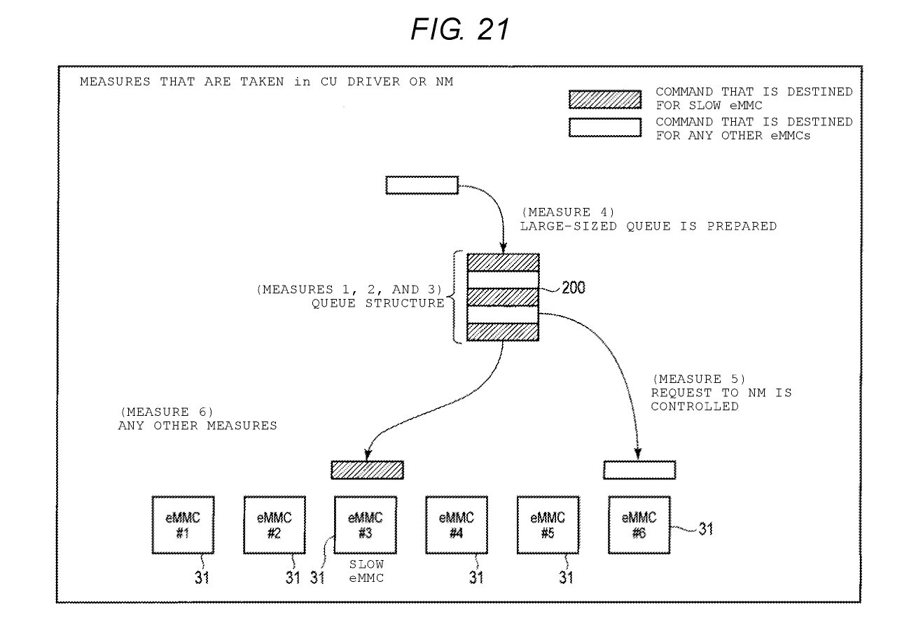

FIG. 21 illustrates measures that are taken in the driver software program (the CU driver) 103 or the NM 30.

(Measures 1, 2, and 3) Queue Structure

Measure 1

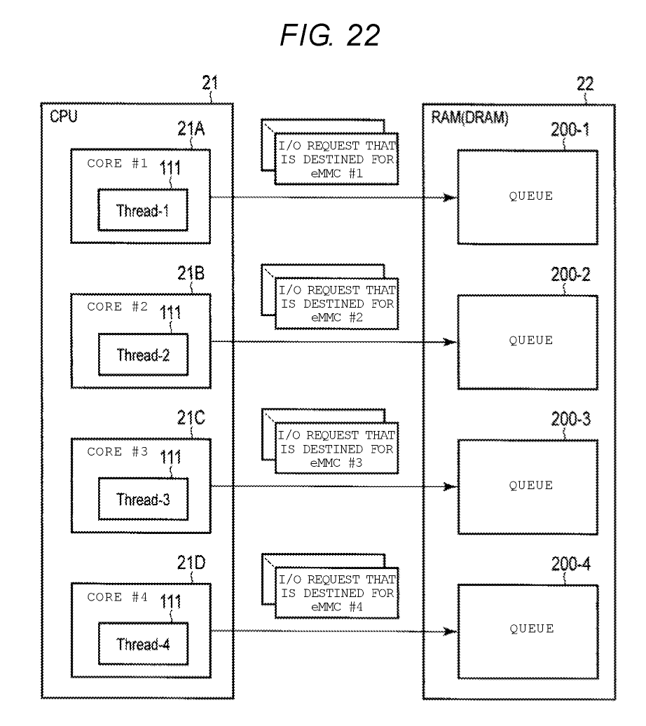

Measure 1: As illustrated in FIG. 22, the queue 200 on the CU is prepared for every CPU core (every processor core) within the CPU 21. In FIG. 22, it is assumed that the CPU 21 includes four cores (core #1, core #2, core #3, and core #4). In this case, four queues 200-1 to 200-4 that correspond these four cores, respectively, are prepared in the RAM (DRAM) 22 of each CU 20.

With the four cores (core #1, core #2, core #3, and core #4), four threads 111 (Thread-1, Thread-2, Thread-3, and Thread-4) are executed at the same time.

Thread-1 that is executed on core #1 issues each of the data I/O requests that are destined for eMMC #1. The data I/O request that is destined for eMMC #1 is entered into the queue 200-1 that corresponds to core #1.

Thread-2 that is executed on core #2 issues each of the data I/O requests that are destined for eMMC #2. The data I/O request that is destined for eMMC #2 is entered into the queue 200-2 that corresponds to core #2.

Thread-3 that is executed on core #3 issues each of the data I/O requests that are destined for eMMC #3. The data I/O request that is destined for eMMC #3 is entered into the queue 200-3 that corresponds to core #3.

Thread-4 that is executed on core #4 issues each of the data I/O requests that are destined for eMMC #4. The data I/O request that is destined for eMMC #4 is entered into the queue 200-4 that corresponds to core #4.

Now, it is assumed that eMMC #1 is the slow eMMC. In this case, it is likely that the queue 200-1 is full of the data I/O requests that are destined for the slow eMMC. However, the data I/O requests issued by Thread-2 to Thread-4 can be entered into the queues 200-2 to the queues 200-4, respectively, without being hindered by the data I/O request that is destined for slow eMMC #1, which is issued by Thread-1.

Furthermore, for example, it is assumed that there are eight threads per CU. A plurality of threads needs to be allocated to one core. A data I/O request of a thread that is allocated to the same core as that to which a thread that puts out the data I/O request which is destined for the slow eMMC is allocated cannot be entered into the corresponding queue, but a data I/O request of any other thread can be entered into any other queue. Accordingly, the concurrency level is raised when compared with a case where there is one queue.

Measure 2

Measure 2: The queue 200 that is long enough is prepared on each CU 20.

For example, the queue 200 can be prevented from being full of the data I/O requests that are destined for the slow eMMC, by preparing the queue 200 with infinite length (infinite depth). Actually, because the queue 200 with infinite length (infinite depth) is hard to prepare, even though a certain eMMC becomes slow, a typical access pattern may determine the queue length (queue depth) that is capable of storing the sufficient number of data I/O requests that are destined for eMMCs other than the slow eMMC.

Measure 3

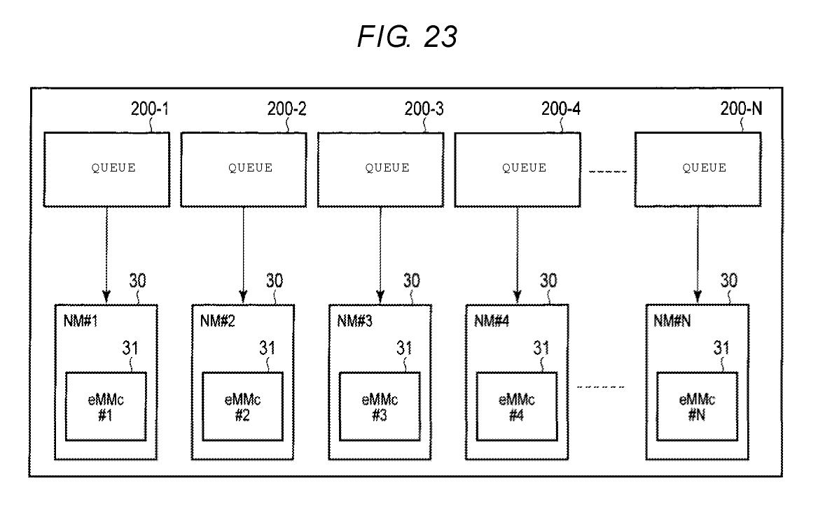

Measure 3: The queue on each CU 20, as illustrated in FIG. 23, is prepared for every eMMC.

In FIG. 23, it is assumed that N queues (queue 200-1, 200-2, 200-3, 200-4, and so forth up to 200-N) that correspond to N eMMCs (eMMC #1, eMMC #2, eMMC #3, eMMC #4, and so forth up to eMMC #N), respectively, are prepared.

By preparing the queue on each CU 20 for every eMMC in this manner, the concurrency level can remain. There are two reasons for this. The first reason is that, when any one of the eMMCs becomes slow, a data I/O request (a command) that is destined for any other eMMC can be carried out and can be sent. The second reason is that, when the latency of the slow eMMC is restored, because there is no situation where the number of commands that are destined for any other eMMC, which are carried out, is small, the command that is destined for any other eMMC can be sent right away.

The measures 1, 2, and 3 relating to the queue structure, which are described above, can be arbitrarily combined.

Measure 4

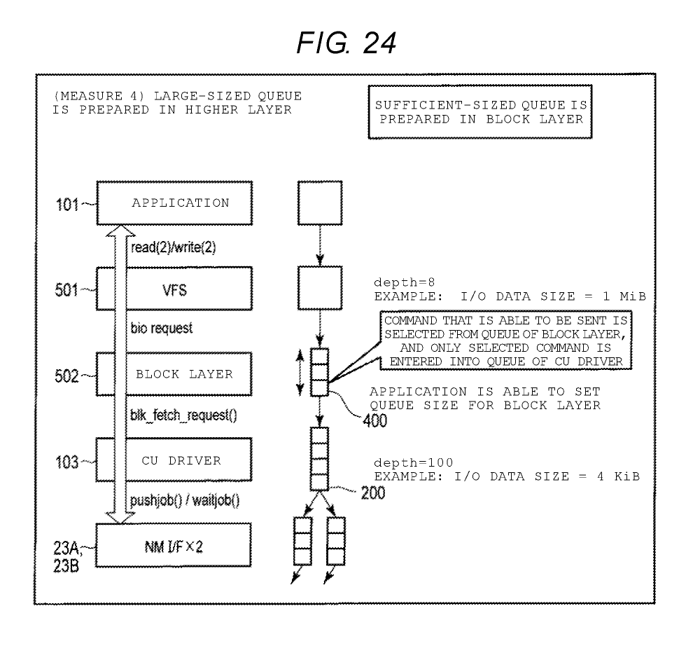

Measure 4: As described in FIG. 24, a large-sized queue is prepared in a higher layer.

As illustrated in FIG. 24, a higher layer software that is managed by the OS 102 is present between the driver software program (the CU driver) 103 and the application software program 101. Each of the data I/O requests that are issued by the application software program 101 is entered into the queue 200 of the driver software program (the CU driver) 103 through a queue 400 of the higher layer software. In FIG. 24, as an example of the higher layer software, a virtual file system (VFS) 501 and a block layer 502 are illustrated. The queue 400 of the higher layer software may be a queue that is managed by the block layer 502.

It is possible that variable configuration of the size (which is also referred to a length or a depth) of the queue 400 is set under the control of the application software program 101. Therefore, the application software program 101 can increase the size of the queue 400 if needed. For example, the application software program 101 may increase the size of the queue 400 when the queue 200 of the driver software program (the CU driver) 103 is likely to be almost full. Accordingly, even though the queue 200 of the driver software program (the CU driver) 103 is full of the data I/O requests that are destined for the slow eMMC, the application software program 101 can issue each of the data I/O requests that are destined for other eMMCs, and can carry out each of the data I/O requests to the queue 400.

On the other hand, when a sufficient empty area is present in the queue 200, the application software program 101 may decrease the size of the queue 400.

Additionally, according to the present embodiment, each of the data I/O requests (the commands) that satisfy a condition for sending is selected from the large-sized queue 400, and only these selected data I/O requests (the commands) are entered into the queue 200 of the driver software program (the CU driver) 103.

For example, if a certain eMMC becomes slow, each of the data I/O requests that are destined for eMMCs other than the slow eMMC is selected from the large-sized queue 400. Then, only each of the selected data I/O requests are entered from the queue 400 into the queue 200.

Accordingly, the data I/O request that is carried out from the queue 400 to the queue 200 is only a data I/O request that is able to be sent. Consequently, it is possible to avoid a situation where the queue 200 is full of the data I/O request that the queue 200 is unable to send (the data I/O request that is destined for the slow eMMC).

Furthermore, in a case the CU 20 has a plurality of NM I/Fs 23 (which are here assumed to be NM I/Fs 23A and 23B), the data I/O request that is carried out to the queue 200 may be divided into two groups that correspond to the NM I/Fs 23A and 23B and thereafter the two groups may be sent through the NM I/Fs 23A and 23B, respectively.

Moreover, if the data size that is designated by one data I/O request which is issued by the application software program 101 is large, this large-sized I/O request may be divided by the driver software program (the CU driver) 103 into, for example, a plurality of 4 KiB data I/O requests, and the plurality of 4 KiB data I/O requests may be entered into the queue 200. The size that results from the division is not limited to 4 KiB.

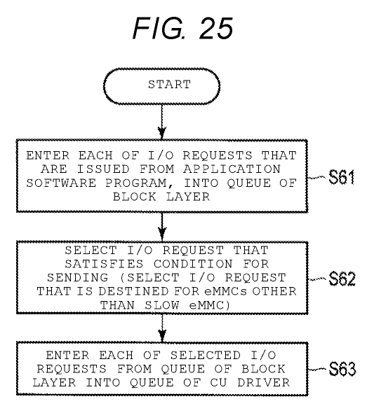

A flowchart in FIG. 25 illustrates a procedure for processing that selects each of the data I/O requests that are able to be sent, from among the data I/O requests that are entered into the queue of the higher layer.

The CPU 21 of each CU 20 enters each of the data I/O requests that are issued by the application software program 101, into the queue 400 of the block layer 502 (Step S61). The CPU 21 selects each of the data I/O requests that satisfy the condition for sending, from among the data I/O requests within in the queue 400 (Step S63).

For example, if the giant latency occurs in a certain eMMC and where the latency of any other eMMC is normal latency, the CPU 21 selects only the data I/O request that is destined for any other eMMC, as the data I/O request that satisfies the condition for sending.

The CPU 21 enters each of the selected data I/O requests into the queue 200 of the driver software program (the CU driver) 103 from the queue 400 of the block layer 502 (Step S63).

In this manner, only the data I/O request that satisfies the condition for sending can be entered into the queue 200 from the queue 400, by selecting in advance the data I/O request that satisfies the condition for sending, from among many data I/O requests that are carried out to the large-sized queue 400. Because all the data I/O requests that are entered into the queue 200 are data I/O requests that are able to be sent, the queue 200 can be prevented from being full of the data I/O requests that are unable to be sent.

Measure 5

Measure 5: A request to the NM is controlled.

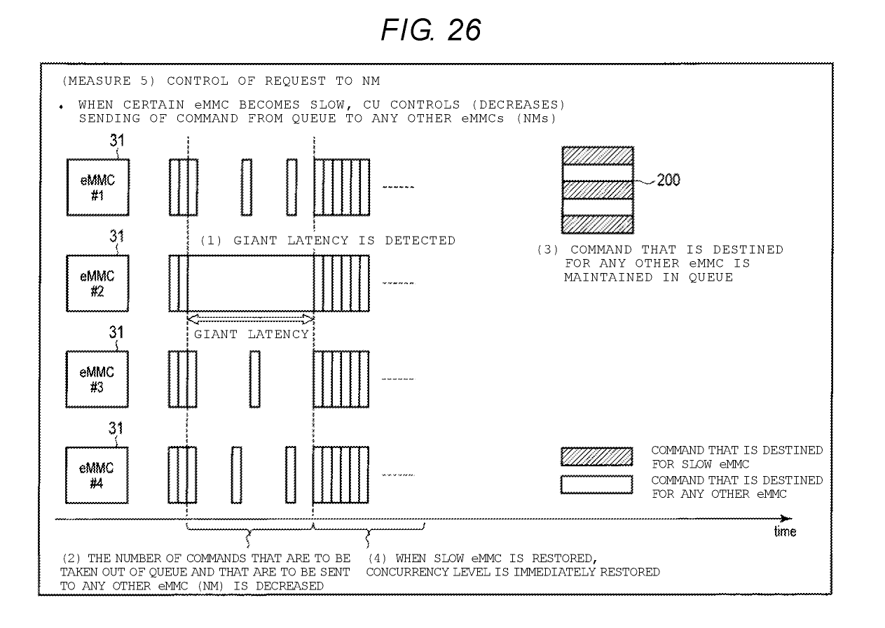

FIG. 26 illustrates an outline of a measure 5. The measure 5 is taken in order to immediately restore the concurrency level just after the giant latency command is ended.

(1) The CPU 21 of each CU 20 detects that a certain eMMC becomes slow, that is, that the giant latency occurs in the eMMC. In FIG. 26, it is assumed that eMMC #2 becomes slow.

(2) The CPU 21 is able to take a command that is destined for an eMMC (eMMC #1, eMMC #3, or eMMC #4) other than eMMC #2, out of the queue 200 and to send the command. However, when it comes to control by the measure 5, the CPU 21 decreases the number of commands that are taken out of the queue 200 and are sent to other eMMCs.

(3) As a result, many commands that are destined for other eMMCs are maintained in the queue 200.

(4) Because a sufficient number of commands that are destined for other eMMCs are maintained in the queue 200, when the latency of the slow eMMC becomes normal, the concurrency level is immediately restored.

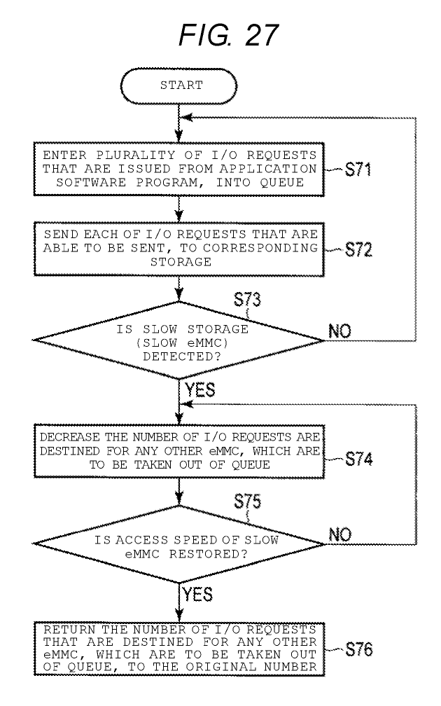

A flowchart in FIG. 27 illustrates a procedure for processing that control the request to the NM.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S71).

The CPU 21 sends each of the data I/O requests within the queue 200, which are able to be sent, toward each of the storages (eMMCs) 31 that correspond to the data I/O requests which are able to be sent (Step S72).

When the CPU 21 detects the slow storage (the slow eMMC) 31 of which access speed becomes slow by performing the background operation (YES in Step S73), the CPU 21 leaves the data I/O request that is destined for the slow eMMC 31, in the queue 200, and sends a data I/O requests that is destined for any other eMMC 31, from the queue 200 to any other eMMC 31. In this case, the CPU 21 decreases the number of data I/O requests that are destined for other eMMCs 31 which have to be taken out of the queue 200 (Step S74). Accordingly, the number of data I/O requests that are destined for other eMMC 31 that are left in the queue 200 can be increased.

Processing that decreases the number of data I/O requests that are destined for other eMMC 31 which are taken out of the queue 200 can be performed by the driver software program (the CU driver) 103.

Thereafter, the CPU 21 determines whether or not the execution of the giant latency command is ended, more specifically, whether or not the access speed of the slow eMMC 31 is restored to the usual access speed (Step S75). If the access speed of the eMMC 31 is restored (YES in Step S75), the CPU 21 increases the number of data I/O requests that are destined for other eMMCs 31 which have to be taken out of the queue 200, to the original number (Step S76). Just after the latency of the slow eMMC 31 is restored, a data I/O request that is destined for any other eMMC 31, as well as the data I/O request that is destined for the eMMC 31 which was slow, is maintained in the queue 200. Therefore, just after the latency of the slow eMMC 31 is restored, the concurrency level can be immediately restored.

Measure 6

Measure 6: The BKOPS of the idle eMMC is started.

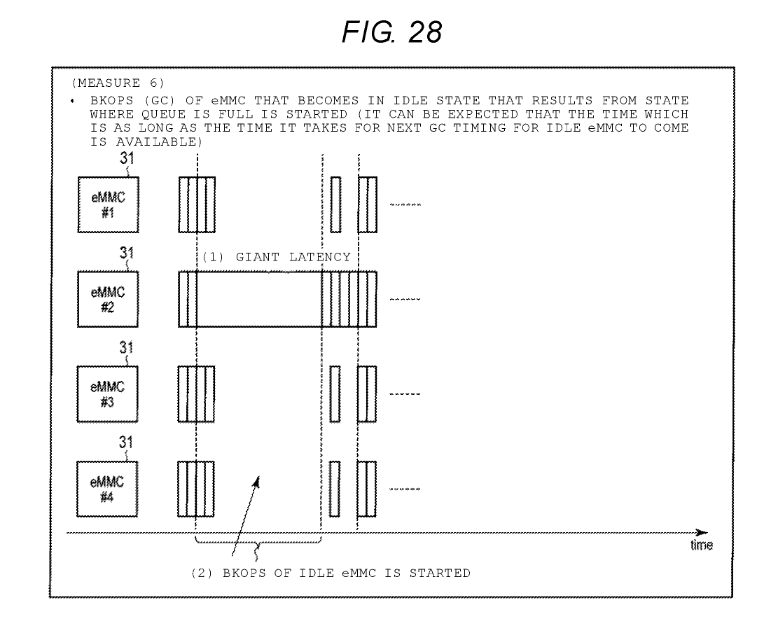

FIG. 28 illustrates an outline of a measure 6.

The measure 6 is taken to cause any other eMMC, which becomes in an idle state that results from a state where the queue 200 is full of the data I/O requests that are destined for the slow eMMC 31, to perform the background operation (the garbage collection (GC)). Accordingly, it can be expected that the time which is as long as the time it takes for the next GC timing for the idle eMMC to come is ensured.

(1) The CPU 21 of each CU 20 detects that a certain eMMC becomes slow, that is, that the giant latency occurs in the eMMC. In FIG. 28, it is assumed that eMMC #2 becomes slow.

(2) If the commands that are destined for eMMC #1, eMMC #3, and eMMC #4 are absent in the queue 200, and where eMMC #1, eMMC #3, and eMMC #4 are in the idle state (the idle eMMC), the CPU 21 instructs each of the idle eMMCs (eMMC #1, eMMC #3, and eMMC #4) to start the background operation.

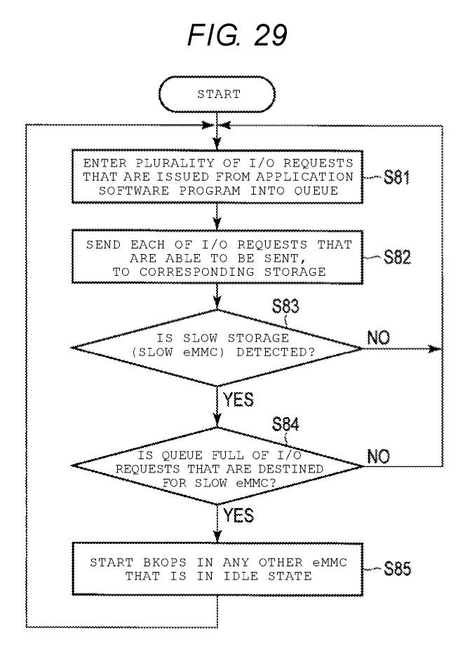

A flowchart in FIG. 29 illustrates a procedure for processing that starts the background operation of the storage that becomes in the idle state.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S81).

The CPU 21 sends each of the data I/O requests within the queue 200, which are able to be sent, toward each of the storages (eMMCs) 31 that correspond to the data I/O requests which are able to be sent (Step S82).

When the CPU 21 detects the slow storage (the slow eMMC) 31 of which access speed becomes slow by performing the background operation (YES in Step S83), the CPU 21 leaves the data I/O request that is destined for the slow eMMC 31, in the queue 200, and sends a data I/O requests that is destined for any other eMMC 31, from the queue 200 to any other eMMC 31.

Then, the CPU 21 determines whether or not the queue 200 is full of the data I/O requests that are destined for the slow eMMC 31 (Step S84).

If the queue 200 is a state of being full of the data I/O requests that are destined for the slow eMMC 31 (YES in Step S84), any other eMMC that becomes in the idle state that results from the state where the queue 200 is full of the data I/O requests is instructed to perform the background operation (the garbage collection), and thus the background operation of any other eMMC is started (Step S85).

Next, Part 2: a method in which performance improvement is achieved by causing the writing command to overlap the giant latency is described.

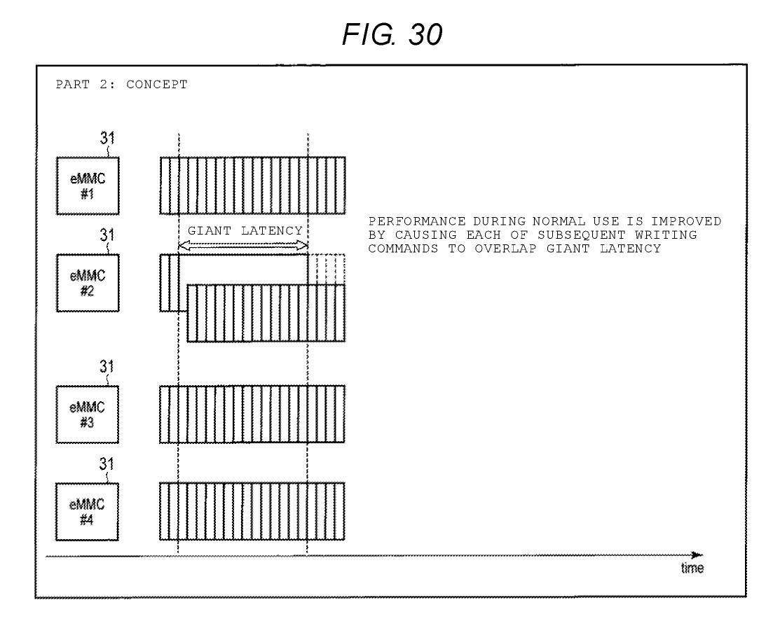

FIG. 30 illustrates the second I/O management (Part 2) that is performed by the storage system.

In FIG. 30, it is assumed that the giant latency occurs in eMMC #2. For a period of time for the giant latency, data cannot be written to eMMC #2. For this reason, the performance during normal use is improved by causing a subsequent writing command that is destined for eMMC #2 to overlap the giant latency.

First, a method in which a processing overlapping function is achieved in cooperation with the application software program 101 will be described.

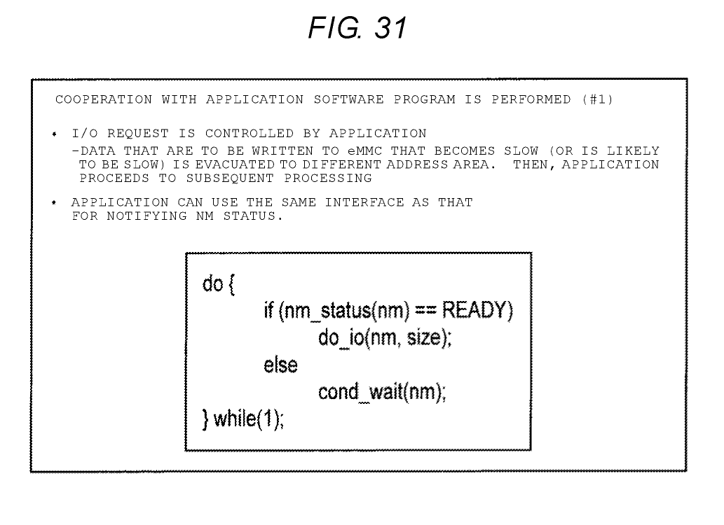

FIG. 31 illustrates an outline of cooperation (#1) with the application.

The application software program 101 is executed to write subsequent data, which are to be written to the eMMC that becomes slow (is likely to become slow), to the reserved save area (another address area), which is different from eMMC #2 that becomes slow (or is likely to become slow). Then, the application software program 101 is executed to proceed to subsequent processing. The cooperation (#1) with this application, for example, can be achieved by the processing that is described with reference to FIGS. 14 and 16. In this case, the application software program 101 can use the same API as the API that is described with reference to FIG. 13 (an interface for notification of the NM status).

When the application software program 101 detects that an eMMC becomes slow (or is likely to be slow), the application software program 101 stops the issuing of the data writing request (the writing command) that is destined for the eMMC that becomes (or is likely to become) slow (or decreases the frequency with which the writing command is issued), and temporarily writes subsequent data, which are to be written to the eMMC that becomes slow (or is likely to become slow), to the reserved save area, which is different from the eMMC that becomes slow (or is likely to become slow). By doing this, even though the issuing of the data writing request (the writing command) that is destined for the eMMC which becomes slow (or is likely to become slow) is stopped (or even though the frequency with which the writing command is decreased), the processing of the subsequent writing command that is destined for the eMMC which becomes slow (is likely to become slow) can be efficiently performed.

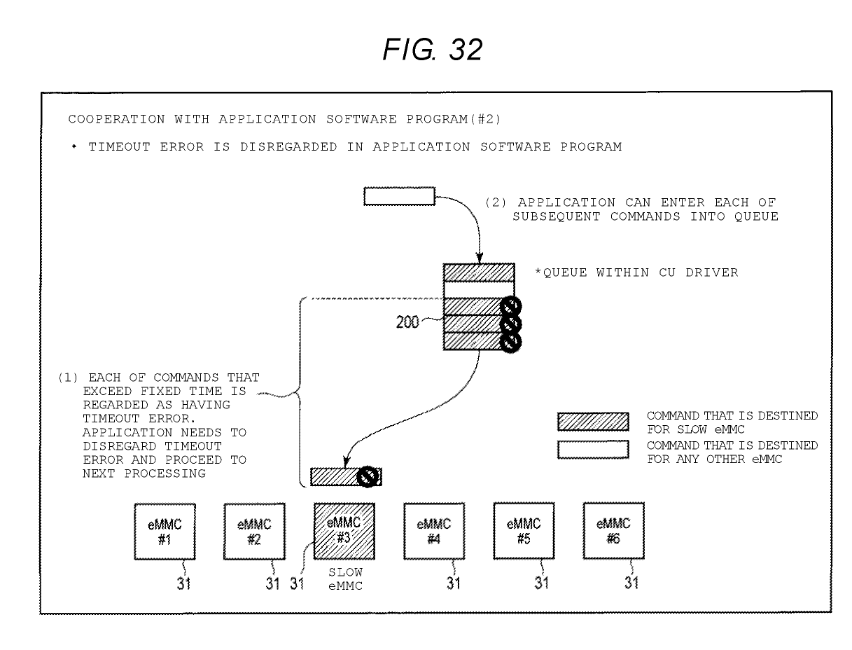

FIG. 32 illustrates an outline of cooperation (#2) with the application.

(1) The driver software program (the CU driver) 103 regards the data I/O request (the command) that exceeds a fixed time after being entered into the queue 200, as having a timeout error, and notifies the application software program 101 of the timeout error of the command. For example, if the giant latency occurs in eMMC #3, the command that is destined for eMMC #3 cannot be sent. For this reason, the command that is destined for eMMC #3 within the queue 200 is regarded as having the timeout error. The application software program 101 disregards the timeout error and proceeds to the following processing. The command that has the timeout error can be destroyed from the queue 200.

(2) The empty area is ensured in the queue 200 by regarding the command that is destined for eMMC #3 within the queue 200, as having the timeout error. Therefore, the application software program 101 can enter a subsequent command into the queue 200.

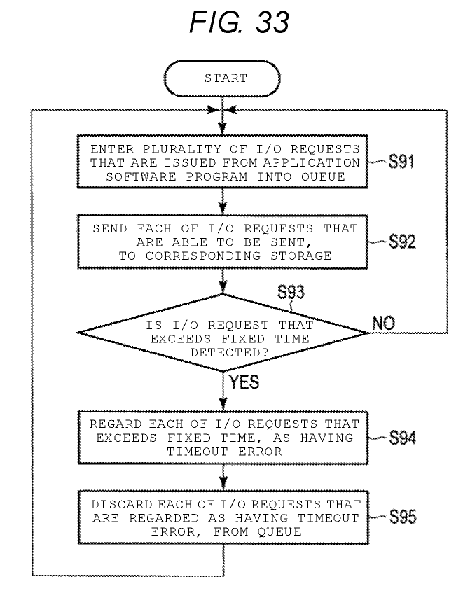

A flowchart in FIG. 33 illustrates a procedure for processing that regards the command which exceeds a fixed time after being entered into the queue, as having the timeout error.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S91).

The CPU 21 sends each of the data I/O requests within the queue 200, which are able to be sent, toward each of the storages (eMMCs) 31 that correspond to the data I/O requests which are able to be sent (Step S92).

The CPU 21 detects the data I/O request that exceeds a fixed time after being entered into the queue 200 (Step S93). If the data I/O request that exceeds a fixed time after being entered into the queue 200 is detected (YES in Step S93), the CPU 21 regards that data I/O request as having the timeout error, and notifies the application software program 101 of the timeout error of the data I/O request (Step S94).

The CPU 21 removes the data I/O request that has the timeout error, from the queue 200 (Step S95). Processing in each of Steps S93 to S95 may be performed by the driver software program (the CU driver) 103.

In this manner, in the cooperation with the application (#2), the data I/O request that exceeds a fixed time is regarded as having the timeout error, and the following data I/O request is processed. This is equivalent to overlapping the giant latency. Furthermore, from the operation described above, the following is understood. In the cooperation with the application (#2), because the timeout error is disregarded, this is useful if the data for which the application software program 101 makes the data I/O request is not actually utilized. As an example of the application software program that does not actually utilize the data for which the data I/O request is made, a test software program and the like that make the data I/O request are considered.

Next, a method in which the processing overlapping function is achieved by the driver software program (the CU driver) 103 or the NM 30 is described.

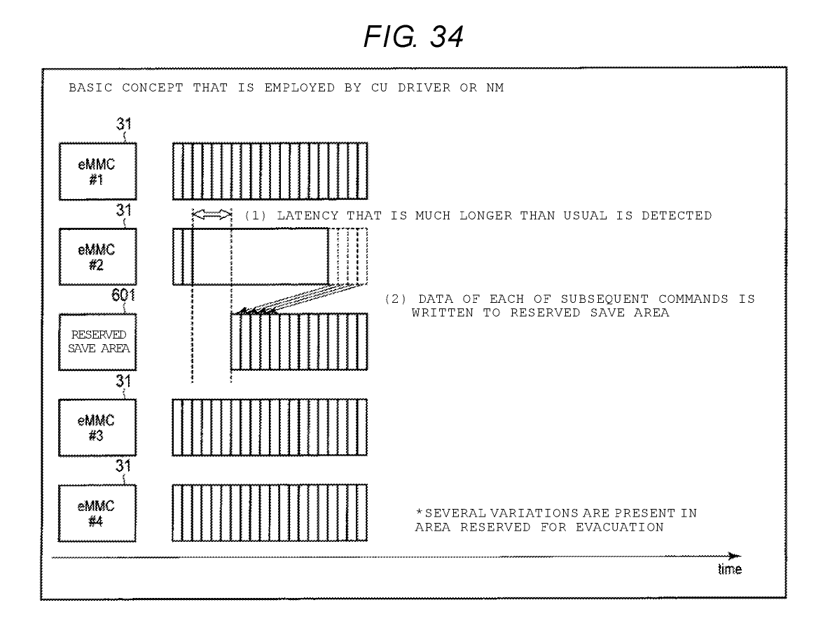

FIG. 34 illustrates the basic concept that is employed by the driver software program (the CU driver) 103 or the NM 30. Moreover, a case where the driver software program (the CU driver) 103 is an entity that performs processing subject will be described below. Although the NM 30 is an entity that performs processing, it is possible that terms or phases are suitably replaced.

In FIG. 34, it is assumed that the giant latency occurs in eMMC #2.

(1) The CPU 21 (for example, the CU driver) of each CU 20 detects the latency that is much longer in eMMC #2 than usual (the giant latency).

(2) The CPU 21 (for example, the CU driver) writes data of each of the subsequent writing commands that are destined for eMMC #2, that is, subsequent data that are to be written to eMMC #2, to a reserved save area 601. By doing this, the processing of each of the subsequent writing commands that are destined for slow eMMC #2 can be caused to overlap the giant latency of slow eMMC #2.

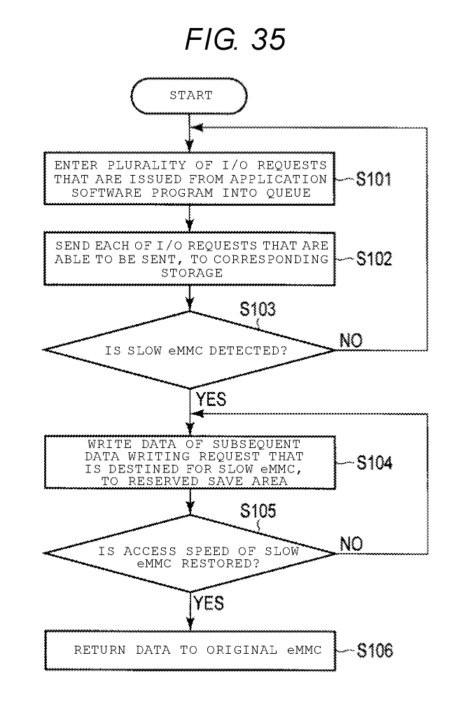

A flowchart in FIG. 35 illustrates a procedure for processing for writing subsequent data that are to be written to the slow storage to the reserved save area.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S101).

The CPU 21 sends each of the data I/O requests within the queue 200, which are able to be sent, toward each of the storages (eMMCs) 31 that correspond to the data I/O requests which are able to be sent (Step S102).

When the CPU 21 detects the slow storage (the slow eMMC) 31 of which access speed becomes slow by performing the background operation (YES in Step S103), the CPU 21 writes data of each of the subsequent data writing requests (the writing commands) that are destined for eMMC #2, to the reserved save area 601 (Step S104). Those writing commands are writing commands that are destined for eMMC #2, which are subsequent to the giant latency command. In Step S104, the driver software program (the CU driver) 103 takes each of the subsequent writing commands that are destined for eMMC #2, out of the queue 200. Then, the driver software program (the CU driver) 103 writes pieces of data that are designated by those writing commands, to the reserved save area 601. In this case, the driver software program (the CU driver) 103 may generate each of the writing commands for writing the pieces of data to the reserved save area 601.

Thereafter, the CPU 21 determines whether or not the execution of the giant latency command is ended, more specifically, whether or not the access speed of the slow eMMC 31 is restored to the usual access speed (Step S105). If the access speed of the eMMC 31 is restored (YES in Step S105), the CPU 21 (for example, the CU driver) returns the data that are written to the reserved save area 601, to the original eMMC 31 (Step S106).

Next, several variations relating to the reserved save area are described.

Variation (1): Toggling Between Two Storages that are Writing Targets

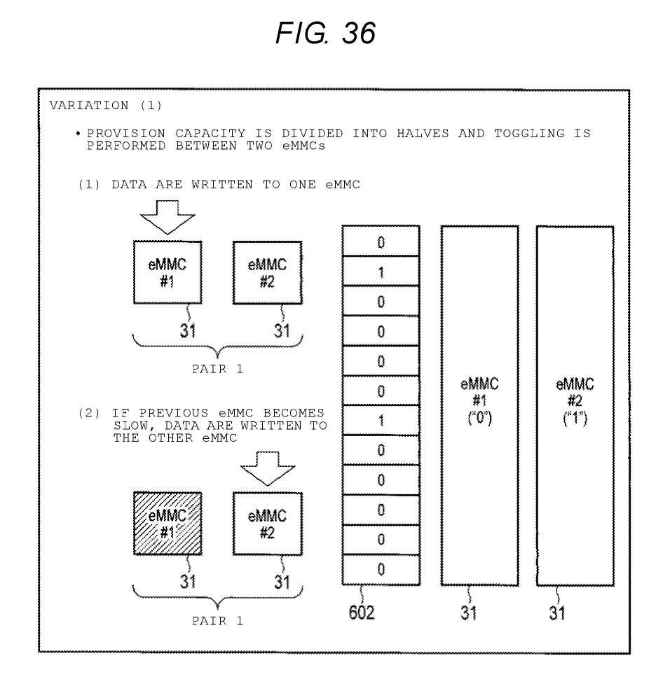

FIG. 36 illustrates an outline of an operation of toggling between two storages that are writing targets.

In FIG. 36, all eMMCs within the data storing area (the storage array) 40 are categorized into a plurality of groups (a plurality of eMMC pairs), each of which includes two eMMCs. The application software program 101 recognizes one eMMC pair as one storage. More precisely, a provision capacity of a storage array 40 is half an actual capacity of the storage array 40. The data writing to each eMMC pair is performed as follows.

(1) The CPU 21 (for example, the CU driver) of each CU 20 writes data to one eMMC within a certain eMMC pair.

(2) If one eMMC becomes slow, the CPU 21 (for example, the CU driver) switches a writing-target eMMC, and writes data to the other eMMC within the eMMC pair. Then, if the other eMMC becomes slow, the CPU 21 (for example, the CU driver) switches a writing-target eMMC, and writes the one eMMC within the eMMC pair.

When an eMMC that is a current writing target becomes slow, it can be expected that the GC of the eMMC that the previous writing target is ended and the latency of the eMMC that is the previous writing target is restored to the usual latency. If the restoring to the normal latency is too slow, the capacity that is provided can be decreased and the number of eMMCs in each group can be increased to 3 or 4. However, usual throughputs are 1/2, 1/3, and 1/4, respectively.

Two eMMCs (eMMC #1 and eMMC #2 here) that make up one eMMC pair have the same capacity. Logical address ranges that correspond to capacities of eMMC #1 and eMMC #2 are allocated to eMMC #1 and eMMC #2, respectively. For example, if the capacity of each of eMMC #1 and eMMC #2 is 32 GB, a LBA range (LBA 0 to LBA n) that corresponds to 32 GB is allocated to each of eMMC #1 and eMMC #2.

A bit map 602 retains information for identifying an eMMC to which the latest data are written. The bit map 602 is created by the CU driver at the time of the data writing. The CU driver can read data from a right eMMC by with reference to the bit map 602.

The bit map 602 stores a bit that corresponds to each of the plurality of address ranges that are obtained by partitioning an LBA range that corresponds to 32 GB into certain management sizes (for example, 4 KiB). Each (“0” or “1”) indicates in which one of eMMC #1 and eMMC #2 the latest data that are written to a corresponding 4 KiB address is present. For example, the bit “0” that corresponds to a certain 4 KiB address range indicates that the latest data which correspond to the 4 KiB address range are written to eMMC #1. On the other hand, the bit “1” that corresponds to a certain 4 KiB address range indicates that the latest data which correspond to the 4 KiB address range are written to eMMC #2. Old data (data in the address range of the eMMC, the writing to which is not performed) may be invalidated by the trimming command.

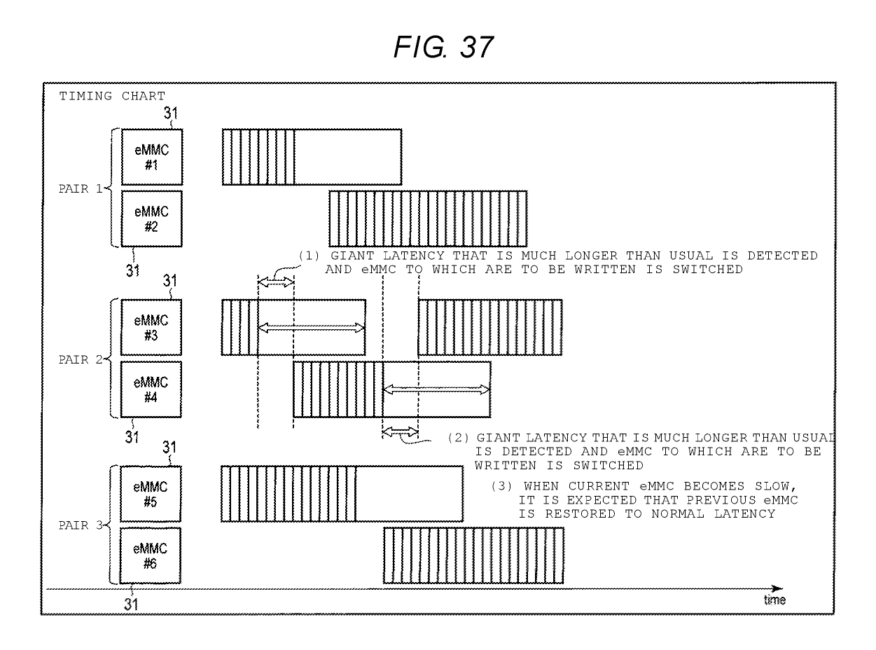

A timing chart in FIG. 37 illustrates an operation of toggling a writing-target storage between two storages.

Here, an operation of performing an operation of writing data to the eMMC pair that includes eMMC #3 and eMMC #4 is described.

(1) The CPU 21 (for example, the CU driver) of each CU 20 first writes data that are to be written to the eMMC pair to eMMC #3 within the eMMC pair. The CPU 21 (for example, the CU driver) detects the latency that is much longer in eMMC #3 than usual. In response to the detection, the CPU 21 (for example, the CU driver) switches the writing target storage from eMMC #3 to eMMC #4.

(2) Then, the CPU 21 (for example, the CU driver) writes subsequent data that are to be written to the eMMC pair to eMMC #4. The CPU 21 (for example, the CU driver) detects the latency that is much longer in eMMC #4 than usual. In response to the detection, the CPU 21 (for example, the CU driver) switches the writing target storage from eMMC #4 to eMMC #3.

(3) When an eMMC that is a current writing target becomes slow, it can be expected that the latency of the eMMC that is the previous writing target is restored to the normal latency.

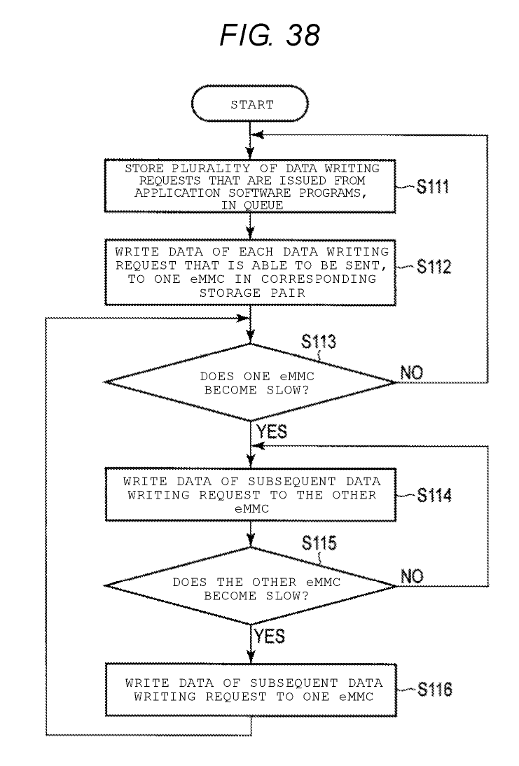

A flowchart in FIG. 38 indicates a procedure for processing that toggles the writing-target storage between two storages.

The CPU 21 of each CU 20 executes the application software program 101. Then, the CPU 21 enters each of the data writing requests that are destined for a plurality of storage pairs (eMMC pairs), which are issued from the application software program 101, into the queue 200 (Step S111).

The CPU 21 writes data that are able to be sent, for which each data writing request was made, to one eMMC within the corresponding storage pair (the eMMC pair) (Step S112).

When the CPU 21 detects that one eMMC becomes slow (YES in Step S113), the CPU 21 writes subsequent data that are destined for the eMMC pair, for which the data writing request was made, to the other eMMC in the eMMC pair (Step S114).

When the CPU 21 detects that the other eMMC becomes slow (YES in Step S115), the CPU 21 writes subsequent data that are destined for the eMMC pair, for which the data writing request was made, to the one eMMC in the eMMC pair (Step S116).

Furthermore, in each of the writing steps (Step S112, Step S114, and Step S116), information that corresponds to the range of addresses at which the writing is performed in the bit map 602 is updated in such a manner as to indicate an eMMC that is a writing destination. Furthermore, old data (data in the address range of the eMMC, the writing to which is not performed) may be invalidated by the trimming command.

Furthermore, according to variation (1), because an eMMC with the same capacity that is a save destination is ensured to pair with a certain eMMC, the capacity of the eMMC that is the save destination is unlikely to be used up. Therefore, as illustrated in Step S106 in FIG. 35, processing that rewrites data is unnecessary.

Variation (2): Writing Data to a Storage Dedicated for Evacuation

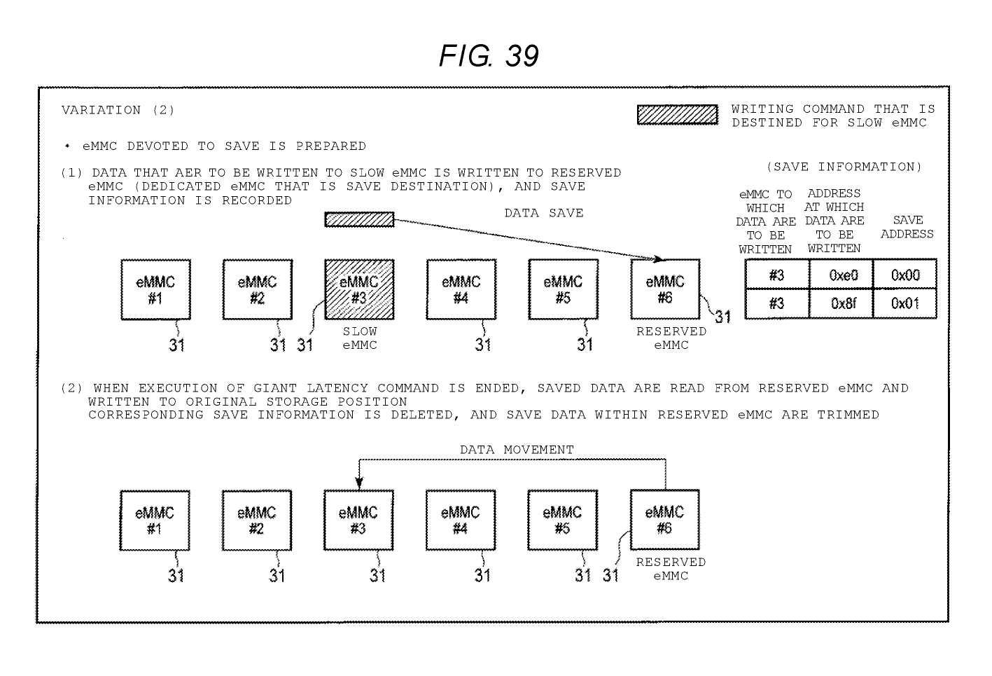

FIG. 39 illustrates an outline of an operation of writing data that are to be written to a slow storage to a storage dedicated to save.

In FIG. 39, the eMMC devoted to save (reserved eMMC) is prepared at a ratio of one eMMC to a plurality of eMMCs. eMMC #1 to eMMC #5 are used as usual eMMCs, and eMMC #6 is used as the eMMC devoted to save (the reserved eMMC). In this case, usual throughput is 5/6. The data writing is performed as follows. Hereinafter, it is assumed that eMMC #3 becomes slow.

(1) The CPU 21 (for example, the CU driver) of each CU 20 writes data destined for slow eMMC #3, for which the data writing request was made, to eMMC #6 reserved for save. In this case, the CPU 21 (for example, the CU driver) may perform address conversion in such a manner that the data destined for slow eMMC #3, for which the data writing request was made, are sequentially written to reserved eMMC #6. For example, a LBA (for example, =0xe0) that are to be written to slow eMMC #3 is converted into a head LBA (for example, =0x00) of reserved eMMC #6. Then, a LBA (for example, =0x8f) of the next data that are to be written to slow eMMC #3 is converted into the next LBA (for example, =0x01) of reserved eMMC #6. Accordingly, data are written to reserved eMMC #6, mostly with the sequential writing. As a result, because the giant latency is less likely to occur in reserved eMMC #6, reserved eMMC #6 can maintain the normal latency for a long period of time.

Then, the CPU 21 (for example, the CU driver) records the save information indicating a relationship between an eMMC and an address, to which data are to be written, and a data save address, as a log. If from the save information, it is determined that data designated by the reading command are stored in reserved eMMC #6, the data are read from reserved eMMC #6.

(2) When the execution of the giant latency command is ended in eMMC #3, the CPU 21 (for example, the CU driver) reads the saved data from the reserved eMMC #6, and writes the read saved data to an original storage position (data movement). The CPU 21 (for example, the CU driver) deletes the corresponding save information, and invalidates the saved data within reserved eMMC #6 by a trimming command. Moreover, in order to avoid simultaneous occurring of the usual access to eMMC #3 and write-back (the data movement) to eMMC #3, the application software program 101 may be executed to provide the CU driver with a hint regarding a timing for the data movement. Alternatively, the application software program 101 may control saving the data to the reserved eMMC #6 and restore the data to the data's original storage position by itself.

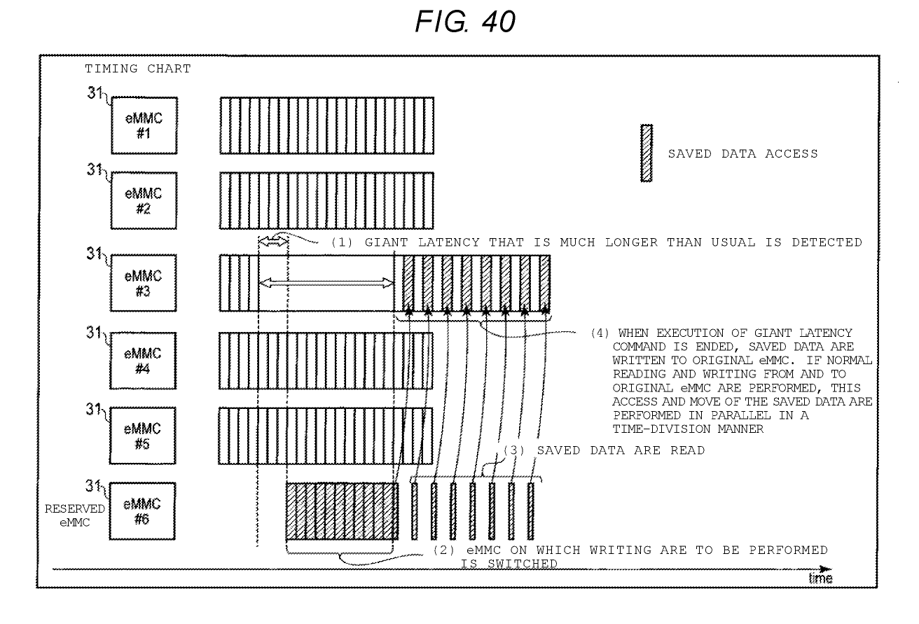

A timing chart in FIG. 40 illustrates an operation in which the data that are to be written to the slow storage are temporarily written to the storage dedicated to save and later that data are returned to the original storage.

(1) The CPU 21 (for example, the CU driver) of each CU 20 detects the latency in eMMC #3 that is much longer than usual.

(2) The CPU 21 (for example, the CU driver) switches the eMMC to which the data of each of the subsequent writing commands that are destined for eMMC #3 are to be written, to eMMC #6 reserved for evacuation. Then, the CPU 21 (for example, the CU driver) writes subsequent data that are to be written to eMMC #3 to reserved eMMC #6. By doing this, the processing of each of the subsequent writing commands that are destined for slow eMMC #3 can be caused to overlap the giant latency of slow eMMC #3.

(3) (4) When the execution of the giant latency command is ended in eMMC #3, the CPU 21 (for example, the CU driver) reads the saved data from the reserved eMMC #6, and writes the read saved data to the original storage position in the original eMMC (eMMC #3). If usual reading and writing from and to the original eMMC is to be performed, the access and the saved data movement are performed in parallel in a time-division manner.

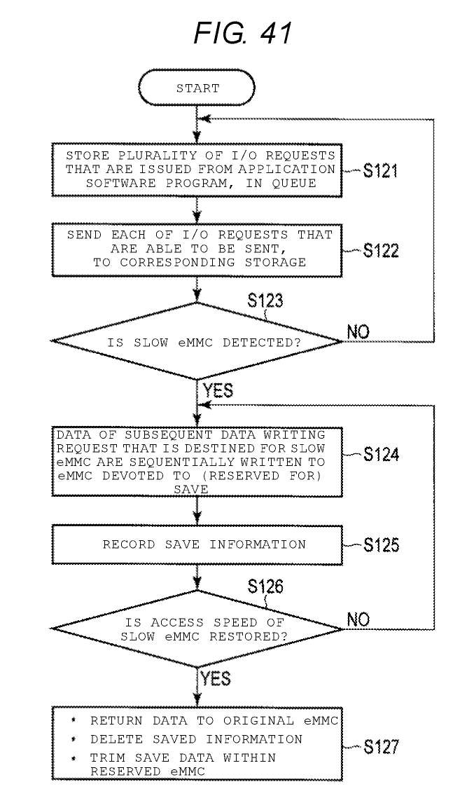

A flowchart in FIG. 41 illustrates a procedure for processing that temporarily writes the data which are to be written to the slow storage to the storage dedicated to save and later returns that data to the original storage.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S121).

The CPU 21 sends each of the data I/O requests within the queue 200, which are able to be sent, toward each of the storages (eMMCs) 31 that correspond to the data I/O requests which are able to be sent (Step S122).

When the CPU 21 detects the slow storage (the slow eMMC) 31 of which access speed becomes slow by performing the background operation (YES in Step S123), the CPU 21 sequentially writes data of each of the subsequent data writing requests (the writing commands) that are destined for the slow eMMC, to the eMMC devoted to save (the reserved eMMC) (Step S124). In Step S124, the driver software program (the CU driver) 103 may take each of the writing commands that are destined for the slow eMMC, out of the queue 200, and may write pieces of data that are designated by those writing commands, to the reserved eMMC. In this case, the driver software program (the CU driver) 103 may generate each of the writing commands for sequentially writing data to the reserved eMMC, and may send those writing command to the reserved eMMC. Then, the driver software program (the CU driver) 103 records the save information (Step S125).

When the access speed of the slow eMMC is restored (YES in Step S126), the CPU 21 returns the saved data to the original storage position in the original eMMC by with reference to the save information, deletes the save information, and then invalidates the saved data within the reserved eMMC (Step S127). The processing in Step S127 can also be performed by the driver software program (the CU driver) 103.

Variation (3): Writing Data to the RAM (the DRAM) 312 within a Certain NM 30.

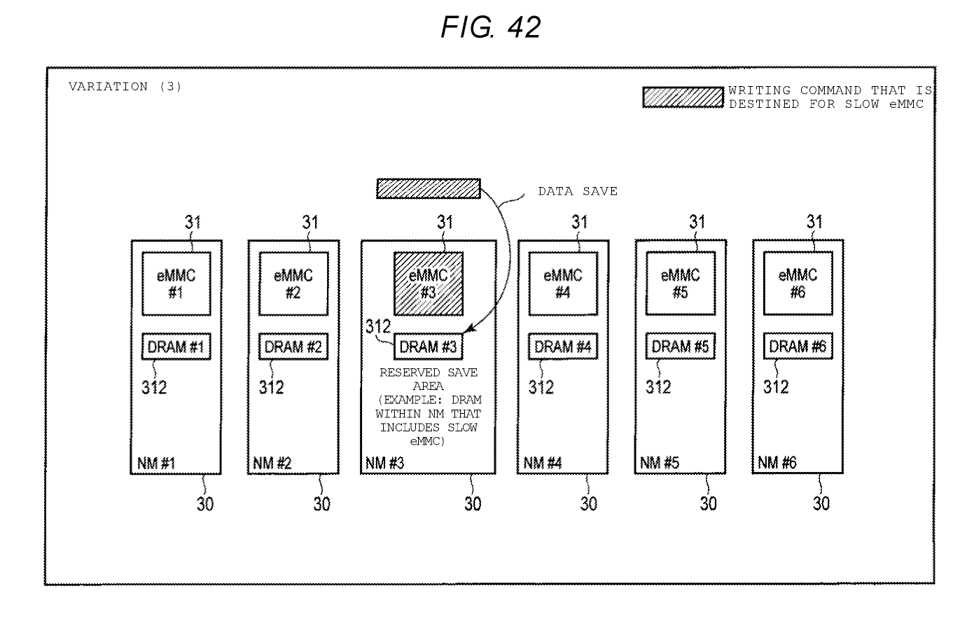

FIG. 42 illustrates an outline of an operation of writing the data that are to be written to the slow storage, to the RAM (the DRAM) within a certain NM.

The basic way of thinking about Variation (3) is the same as that about Variation (2).

There are three advantages of Variation (3) that follow.
The usual throughput can be maintained.
The provision capacity can be maintained.
Because the giant latency never occurs in a reserved area (the DRAM), completion of data save within a certain period of time can be guaranteed.

The following two disadvantages of Variation (3) are considered.
Limited Capacity of the DRAM. A capacity of the DRAM for save is smaller than that of the eMMC for save.
Data in the DRAM is lost when unexpected power-off takes place.

Basically, the DRAM for save may be a DRAM within any NM. As a typical example of the DRAM for save, a DRAM within the NM that includes the slow eMMC is given. In this case, because data is written, as the saved data, to the NM including the eMMC to which the data are to be written, the saved data is easy to manage.

For example, if eMMC #3 becomes slow, data of the subsequent writing command that are destined for eMMC #3 are written the DRAM within the NM including eMMC #3.

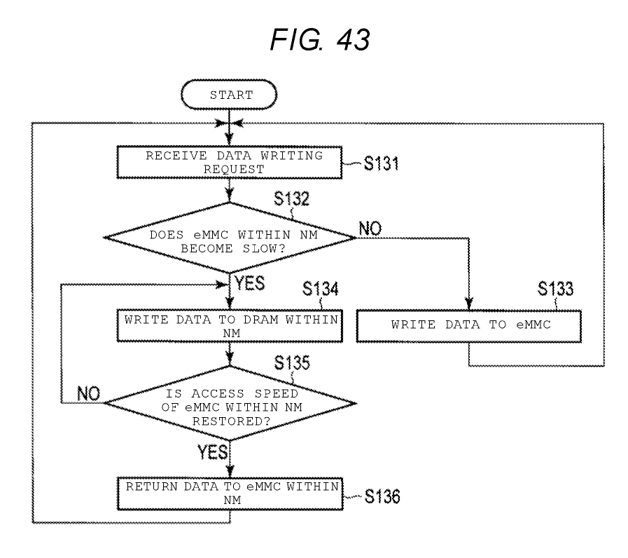

A flowchart in FIG. 43 illustrates a procedure for processing of temporarily writing the data which are to be written to the slow storage to the DRAM within the NM and later returns that data to the original storage.

Hereinafter, it is assumed that the CPU 311 within the NM controls the save of the data and the data movement to the original storage position.

The CPU 311 of the NM receives the data writing request that is destined for the NM (Step S131). The CPU 311 determines whether or not the eMMC within the NM becomes slow (Step S132). If the eMMC within the NM does not become slow (NO in Step S132), the CPU 311 writes data designated by the data writing request, to the eMMC within the NM (Step S133).

On the other hand, if the eMMC within the NM becomes slow (YES in Step S132), the CPU 311 writes the data designated by the data writing request, to the DRAM 312 within the NM (Step S134). Then, when the access speed of the eMMC within the NM is restored (YES in Step S135), the CPUs 311 returns the saved data from the DRAM within the NM to the original storage position in the eMMC within the NM (Step S136).

Variation (4): Ensuring of the Reserved Save Area in Each eMMC.

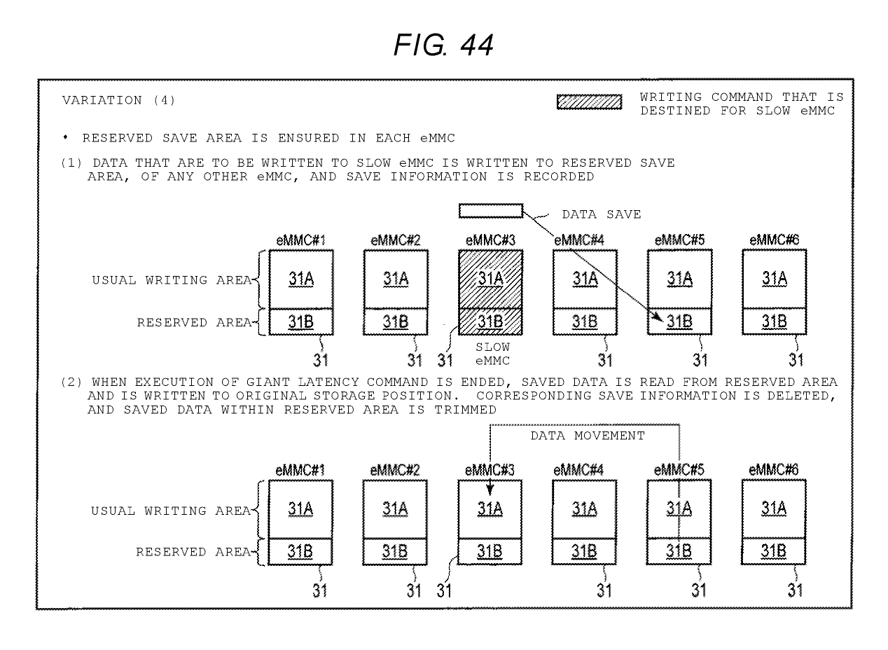

FIG. 44 illustrates an outline of an operation in which the data that are to be written to the slow storage are written to a reserved save area within any other storage.

In FIG. 44, each of eMMC #1, eMMC #2, eMMC #3, eMMC #4, eMMC #5, and eMMC #6 includes a usual writing area 31A and a reserved save area 31B. More precisely, one portion of a storage area of each eMMC is used as the reserved save area. In this case, because all eMMC #1 to eMMC #6 are able to be used for usual reading and writing accesses, the usual throughput is maintained to the maximum (6/6).

The data writing is performed as follows. Here, it is assumed that eMMC #3 becomes slow.

(1) The CPU 21 (for example, the CU driver) of each CU 20 writes data destined for slow eMMC #3, for which the data writing request was made, to an area reserved for any other eMMC (an eMMC that is not slow). FIG. 44 illustrates a case where the data are written to the reserved save area 31B of eMMC #5. When the giant latency occurs, because the eMMC that is a save destination (eMMC #5 here) processes both of the usual reading and writing from and to eMMC #5 and the writing for the data save, the use of the eMMC that is the save destination takes twice as much time as is usually used. If all eMMCs become slow for the same period of time, this is meaningless, but usually, it is less likely that a plurality of eMMCs will become slow for the same period of time. Then, the CPU 21 (for example, the CU driver) records the save information (not illustrated) indicating a relationship between a data's original storage position in an eMMC and an address, to which data are to be written, and an eMMC that is a save destination of the data and an address, as a log.

(2) When the execution of the giant latency command is ended in eMMC #3, the CPU 21 (for example, the CU driver) reads the saved data from the reserved area 31B of eMMC #5, and writes the read saved data to the original storage position (the data movement). The CPU 21 (for example, the CU driver) deletes the corresponding save information, and invalidates the saved data within the reserved area 31B of eMMC #5 by the trimming command.

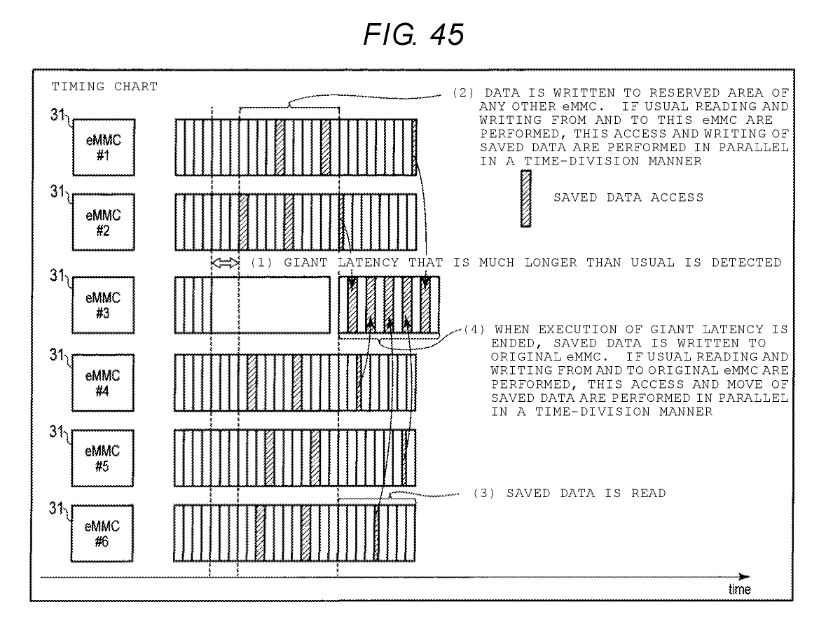

A timing chart in FIG. 45 illustrates an operation in which the data that are to be written to the slow storage are temporarily written to a reserved save area within any other storage, and later that data are returned to the original storage.

(1) The CPU 21 (for example, the CU driver) of each CU 20 detects the latency that is much longer in eMMC #3 than usual (the giant latency).

(2) The CPU 21 (for example, the CU driver) writes data of each of the subsequent writing commands that are destined for eMMC #3, to a reserved area within any other eMMC. FIG. 45 illustrates a case where pieces of data of the subsequent writing command that are destined for eMMC #3 are distributed in this sequence: a reserved area within eMMC #2, a reserved area within eMMC #4, a reserved area within eMMC #6, a reserved area within eMMC #5, a reserved area within eMMC #1. Alternatively, the pieces of data of the subsequent writing command that are destined for eMMC #3 may be sequentially written to a reserved area of a single eMMC other than eMMC #3.

(3) (4) When the execution of the giant latency command is ended in eMMC #3, the CPU 21 (for example, the CU driver) reads the saved data from a reserved area of any other eMMC, and writes the read saved data to the original storage position within a usual writing area of the original eMMC (eMMC #3). If the usual reading and writing from and to the original eMMC is to be performed, the access and the saved data movement are performed in parallel in a time-division manner.

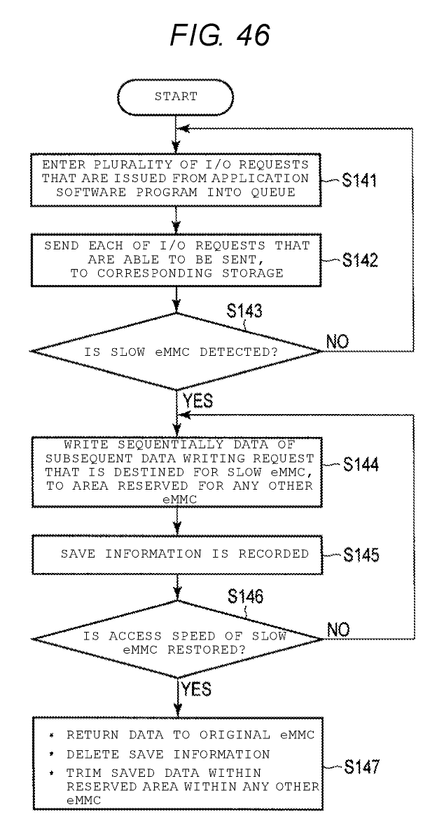

A flowchart in FIG. 46 illustrates a procedure for processing that temporarily writes the data that are to be written to the slow storage to a reserved save area within any other storage, and later returns that data to the original storage.

The CPU 21 of each CU 20 executes the application software program 101. Then, the CPU 21 enters each of the data I/O requests that are destined for the plurality of storages (eMMCs) 31, which are issued from the application software program 101, into the queue 200 (Step S141).

The CPU 21 sends each of the data I/O requests within the queue 200, which are able to be sent, toward each of the storages (eMMCs) 31 that correspond to the data I/O requests which are able to be sent (Step S142).

When the CPU 21 detects the slow storage (the slow eMMC) 31 of which access speed becomes slow by performing the background operation (YES in Step S143), the CPU 21 writes data of each of the subsequent data writing requests (the writing commands) that are destined for the slow eMMC, to a reserved area of any other eMMC (Step S144). In Step S144, the driver software program (the CU driver) 103 may take the writing command that is destined for the slow eMMC, out of the queue 200, and may write data designated by that writing command, to a reserved area of any other eMMC. In this case, the driver software program (the CU driver) 103 may be executed to generate a writing command that includes an LBA for sequentially writing data to the reserved area of any other eMMC, and send the writing command to any other eMMC. Moreover, pieces of data of each of the subsequent writing commands that are destined for the slow eMMC may be distributed to reserved areas of several eMMCs other than the slow eMMC.

Then, the driver software program (the CU driver) 103 records the save information (Step S145).

When the access speed of the slow eMMC is restored (YES in Step S146), the CPU 21 returns the saved data to the original storage position in the usual writing area of the original eMMC with reference to the save information, deletes the save information, and then invalidates the saved data within the reserved area of any other eMMC (Step S147). The processing in Step S147 can also be performed by the driver software program (the CU driver) 103.

Other Measures

Next, measures for preventing the giant latency from occurring if possible are described.

As described above, because the giant latency occurs with difficulty at the time of the sequential writing, a condition for executing the application software program 101 may be limited in such a manner that a pattern of access to each eMMC is sequentially written.

If a plurality of threads write pieces of data to the same eMMC, even though each thread sequentially performs writing, the combined pattern of the access to the eMMC is not sequential written. Therefore, for example, one thread may sequentially perform the writing, and may limit the condition for executing the application software program 101 in such a manner that only the one thread can perform the writing to a specific eMMC.

Furthermore, as described above, the higher the ratio (the percentage) of the range of the random writing to the capacity of the storage, the more the giant latency is likely to occur. Therefore, for example, only an area of a 64 GB eMMC, which ranges in size from 0 to 32 GB, may be used as a user's area that is available for use.

As described above, according to the function that is described in Part 1 of the present embodiment, if the slow storage is detected, the issuing by the application software program 101 of the data I/O request that is destined for that slow storage is stopped. Accordingly, the queue 200 can be prevented from being full of the data I/O requests that are destined for the slow storage. Therefore, even though a certain storage becomes slow, because a data I/O request that is destined for any other storage (a storage that is not slow) can be entered into the queue 200, even for a period of time during which a certain storage becomes slow, each of the storages that are not slow can be efficiently accessed. Consequently, a situation in which access to any other storage (a storage that is not slow) becomes slow as well due to a certain storage becoming slow can be prevented from occurring, and thus a decrease in performance of the storage system 1 can be stopped to a minimum level.

Furthermore, with the function of predicting the storage that is likely to be slow, before an access speed of a certain storage becomes actually slow, the number of data I/O requests that are destined for the certain storage is decreased. Therefore, even though the access speed of the storage actually becomes slow, it can be expected that the queue 200 can be prevented from being full of the data I/O requests that are destined for the slow storage.

Additionally, in cooperation with the application software program 101, the data that are to be written to the slow storage or the storage which is likely to become slow can be written to reserved save area.

Furthermore, according to the function that is described in Part 2 of the present embodiment, because the writing command can be caused to overlap the giant latency, an improvement in the performance of the storage system 1 can be achieved.

Moreover, each of the functions that are described according to the present embodiment may be used independently, and may be used in combination with one or more arbitrary functions.

Furthermore, according to the present embodiment, the system including a plurality of CPUs 21 and a plurality of storages 31 is described, but it is possible that each function that is described according to the present embodiment is applied to a system including one or more CPUs 21 and a plurality of storages 31.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage system comprising:
a plurality of nodes, each of the nodes including a nonvolatile storage device; and
a connection unit directly connected to at least one of the nodes and having a processor configured to
store each of input or output (I/O) commands in a queue,
issue each of the I/O commands stored in the queue to one of the nodes,
determine a busy node based on a status received therefrom, and
selectively generate I/O commands for storage in the queue so that I/O commands targeting non-busy nodes are generated and I/O commands targeting busy nodes are not generated.

2. The storage system according to claim 1, wherein
the processor is further configured to generate an additional background operation command directed to the busy node upon determination of the busy node, and issue the additional background operation command to the busy node.

3. The storage system according to claim 1, wherein
the processor is further configured to determine that the busy node has become non-busy, and resume generating I/O commands targeting the busy node that has become non-busy.

4. The storage system according to claim 1, wherein
the processor is further configured to issue a write command that would have been issued to the busy node, to a non-busy node.

5. The storage system according to claim 4, wherein
when the processor determines that the busy node has become non-busy, the processor issues a copy command to the non-busy node, in which data of the write command were written, to copy the data to the busy node that has become non-busy.

6. The storage system according to claim 1, wherein
the processor is further configured to determine a node to be quasi-busy based on a statistical information thereof, and reduce the number of I/O commands targeting the quasi-busy node that are generated.

7. The storage system according to claim 6, wherein
the processor is further configured to issue a write command that would have been issued to the quasi-busy node, to a non-busy node.

8. The storage system according to claim 7, wherein
when the processor determines that the quasi-busy node has become non-busy, the processor issues a copy command to the non-busy node, in which data of the write command were written, to copy the data to the quasi-busy node that has become non-busy.

9. The storage system according to claim 1, wherein
the processor includes a first core in which a first thread is executed, and a second core in which a second thread is executed, and
the queue includes a first sub-queue in which I/O commands generated in accordance with execution of the first thread are stored, and a second sub-queue in which I/O command generated in accordance with execution of the second thread are stored.

10. The storage system according to claim 1, wherein
the queue includes a plurality of sub-queues each of which corresponds to one of the nodes, and I/O commands for a node are stored in one of the sub-queues corresponding thereto.

11. The storage system according to claim 1, wherein
each of the nodes becomes busy when the nodes carries out garbage collection.

12. The storage system according to claim 1, wherein
the processor is further configured to reduce the number of I/O commands targeting non-busy nodes when the busy node is determined.

13. The storage system according to claim 1, wherein
the processor is further configured to remove I/O commands that are stored in the queue for over a predetermined period of time.

14. A storage system comprising:
a plurality of nodes, each of the nodes including a nonvolatile storage device; and
a connection unit directly connected to at least one of the nodes and having a processor configured to
store each of input or output (I/O) commands in a queue,
issue each of the I/O commands stored in the queue to one of the nodes,
determine a node to be quasi-busy based on a statistical information thereof, and
reduce the number of data I/O commands targeting the quasi-busy node that are generated.

15. The storage system according to claim 14, wherein
the processor is further configured to issue a write command that would have been issued to the quasi-busy node, to a non-busy node.

16. The storage system according to claim 15, wherein
when the processor determines that the quasi-busy node has become non-busy, the processor issues a copy command to the non-busy node, in which data of the write command were written, to copy the data to the quasi-busy node that has become non-busy.

17. A method for operating a connection unit that directly connected to at least one of a plurality of nodes, wherein each of the nodes includes a nonvolatile storage device, said method comprising:
generating input or output (I/O) commands directed to the plurality of nodes;
storing each of the generated data I/O commands in a queue;
transmitting each of the data I/O commands stored in the queue to one of the nodes;
determining a busy node based on a status received therefrom; and
selectively generating I/O commands for storage in the queue so that I/O commands targeting non-busy nodes are generated and I/O commands targeting busy nodes are not generated.

18. The method according to claim 17, further comprising:
upon determining the busy node, generating an additional background operation command directed to the busy node, and issuing the additional background operation command to the busy node.

19. The method according to claim 17, further comprising:
determining that the busy node became non-busy, and
upon determining that the busy node became non-busy, resuming generation of I/O commands targeting the busy node that became non-busy.

20. The storage system according to claim 19, further comprising:
upon determining the busy node, issuing a write command that would have been issued to the busy node, to a non-busy node.
